(19) United States
(12) Patent Application Publication
(10) Pub. No.: US 2026/0235415 A1
(43) Pub. Date: Aug. 13, 2026

(54) MAP ANNOTATION DATA GENERATION FOR AUTONOMOUS VEHICLES

(71) Applicant: Five AI Limited, Cambridge (GB)

(72) Inventor: Jared Khan, Cambridge (GB)

(73) Assignee: Five AI Limited, Cambridge (GB)

(21) Appl. No.: 19/156,348

(22) PCT Filed: Feb. 13, 2024
(86) PCT No.: PCT/EP2024/053643

§ 371 Date: Aug. 13, 2025

(30) Foreign Application Priority Data
Feb. 14, 2023 (GB) 2302089.4

(51) Int. Cl. G01C 21/00; G01C 21/36; G09B 29/10

(52) U.S. Cl. CPC G01C 21/3815; G01C 21/3673; G09B 29/106

(57) ABSTRACT

A computer-implemented method of generating road annotation data for annotating an electronic map, the method comprising accessing from persistent storage an electronic map defining a road network; generating a road topology graph encoding a topology of the road network, the road topology graph comprising nodes representing road structure elements and edges representing links between road structure elements; performing a search of the road topology graph for a predetermined graph structure; responsive to identifying a subgraph of the road topology graph exhibiting the predetermined graph structure, generating annotation data for marking in the electronic map a portion of the road network corresponding to the subgraph; and generating in persistent storage an augmented map comprising map data defining the portion of the road network and the annotation data.

### TECHNICAL FIELD

The present disclosure pertains to support tools for autonomous vehicles. Such tools have offline applications to support the development and testing of autonomous vehicle systems (including simulation-based testing), as well as online applications within an autonomous vehicle system to facilitate real-time planning, prediction and/or other online functions.

### BACKGROUND

There have been major and rapid developments in the field of autonomous vehicles. An autonomous vehicle (AV) is a vehicle which is equipped with sensors and control systems which enable it to operate without a human controlling its behaviour. An autonomous vehicle is equipped with sensors which enable it to perceive its physical environment, such sensors including for example cameras, radar and lidar. Autonomous vehicles are equipped with suitably programmed computers which are capable of processing data received from the sensors and making safe and predictable decisions based on the context which has been perceived by the sensors.

An autonomous vehicle may be fully autonomous (in that it is designed to operate with no human supervision or intervention, at least in certain circumstances) or semi-autonomous. Semi-autonomous systems require varying levels of human oversight and intervention. An Advanced Driver Assist System (ADAS) and certain levels of Autonomous Driving System (ADS) may be classed as semi-autonomous. A “level 5” vehicle is one that can operate entirely autonomously in any circumstances, because it is always guaranteed to meet some minimum level of safety. Such a vehicle would not require manual controls (steering wheel, pedals etc.) at all. By contrast, level 3 and level 4 vehicles can operate fully autonomously but only within certain defined circumstances (e.g. within geofenced areas). A level 3 vehicle must be equipped to autonomously handle any situation that requires an immediate response (such as emergency braking); however, a change in circumstances may trigger a “transition demand”, requiring a driver to take control of the vehicle within some limited timeframe. A level 4 vehicle has similar limitations; however, in the event the driver does not respond within the required timeframe, a level 4 vehicle must also be capable of autonomously implementing a “minimum risk maneuver” (MRM), i.e. some appropriate action(s) to bring the vehicle to safe conditions (e.g. slowing down and parking the vehicle). A level 2 vehicle requires the driver to be ready to intervene at any time, and it is the responsibility of the driver to intervene if the autonomous systems fail to respond properly at any time. With level 2 automation, it is the responsibility of the driver to determine when their intervention is required; for level 3 and level 4, this responsibility shifts to the vehicle's autonomous systems and it is the vehicle that must alert the driver when intervention is required.

The ability to precisely capture and describe driving scenarios is a cornerstone of autonomous vehicle technology. A typical driving scenario includes a static road layout and various dynamic agents (other vehicles, pedestrians, cyclists, animals etc.) that an autonomous vehicle (the ego vehicle) is required to navigate. An ego vehicle may be required to predict the motion of other agents and plan safely within a complex road network. In an online context, prediction and planning components require a scenario description that is sufficiently detailed and precise. In an offline context, a scenario description may be required as an input to a simulator to facilitate simulation-based testing of an autonomous vehicle stack prior to deployment on a real-world vehicle.

“High definition” (HD) maps of road networks, typically to centimetre precision, may be used in an online context in combination with a localization method (to determine an ego vehicle location on the map). In such online contexts, an HD map provides the ego vehicle with greater awareness of its surroundings, typically supplementing its own sensor readings. In an offline context, an HD map may be used as a static layer in a simulation environment, on which a virtual ego agent is tested before real-world deployment. For example, ASAM OpenDRIVE® is an XML-based schema that allows road networks to be described to a high level of precision in a hierarchical fashion. Roads are described by road elements (<road>), connectable via link elements (<link>) within the road elements. Junction elements (<junction>) are required when linking more than two roads. Every road element is characterized by a single road reference line constructed from parameterized geometric elements. OpenDRIVE denotes longitudinal and latitudinal coordinates with respect to the reference line as “s” and “t” (reference line coordinates). Lanes are described by lane elements (<lane>) within a road element. Every road element must contain a center lane element of width zero and at least one “side-lane” element of non-zero width. The center lane serves as a reference for lane numbering. By default, the center lane lies along the road reference line, but can be offset from it. For conciseness, “side-lanes” may be referred to herein simply as lanes where the meaning is unambiguous. Side-lanes may have a fixed or variable width. A side-lane may have a width of zero along a given stretch of road, but zero-width side lanes for long distances should be avoided. Road elements may be divided into sections (lane sections) to accommodate roads with changing numbers of lanes, where each lane section has a fixed number of lanes. Roads and junctions are assigned string identifiers that should be unique within a road network. Lanes are identified via incremental lane numbering relative to the center lane, and the lane numbers are only unique within a lane section. Individual lanes within two linked roads may be linked via additional link elements within the lane elements. Road/lane geometries are described in terms of functions, where the functions can change along the road (for example, a road reference line might be described as a straight line function on a given interval, followed by a spiral function, and then an arc function; a lane might be described in terms of a width function that is constant on some interval, and then changes to a linearly increasing function etc.). ASAM OpenSCENARIO® defines a file format for the description of dynamic driving scenario content, which may be used in combination with OpenDRIVE. The stated purpose of OpenDRIVE “is to provide a road network description that can be fed into simulations to develop and validate ADAS and AD [Autonomous Driving] features” [1].

In OpenDRIVE, not all side-lanes are drivable. Rather “side-lane” is a broad concept to describe any road geometry. Examples of non-drivable side lines include restricted areas, pavements/sidewalks, hedgerows etc. Each side lane has configurable attributes which, among other things, indicate whether or not it is drivable.

### SUMMARY

A ‘basic’ HD map typically describes the geometry and topology of lanes (or side-lanes) within a road network, and the lane types/attributes. In OpenDRIVE, the core elements required to describe road networks are essentially roads, side-lanes, links and junctions. Junction elements are used as a general mechanism to define road interconnections and a junction element is required when linking three or more roads. A such, junction elements encompass a wide range of junction structures/topologies. Map annotations are a form of metadata used to augment the core road structures. Map annotations are not required to describe the road network, and the map is useable without such annotations. However, map annotations can provide additional and useful context. For example, in OpenDRIVE, a junction group element may optionally be used to group a set of junctions (e.g. junctions belonging to a roundabout). A junction group element may be included when the map is created, or a map may be subsequently annotated.

Map annotations may be used in simulation-based testing. For example, when assessing the performance of a virtual ego agent in a test scenario, different performance evaluation rule sets may be applied in different driving contexts. For example, a specific set of performance evaluation rules may be used to test ego performance in a roundabout context (entering, navigating and/or exiting a roundabout). In some cases, different rule sets may be used in different intervals of a test scenario. In such contexts, a map annotation may be used to select an appropriate rule set for a test scenario or an interval within a scenario (e.g. switching to a roundabout-specific rule set as the ego agent approaches an annotated roundabout). In an online context, map annotation may be used to assist in real-time functions such as motion prediction and planning.

Another use-case for map annotations in determining testing coverage. For example, an operational design domain (ODD) for a stack might specify that the stack is required to operate to a specified level in roundabout contexts (or certain roundabout contexts). Verifying the ODD requirements typically requires some minimum number of test scenarios covering the full extent of the ODD. Map annotations can be used to verify that e.g. the stack has encountered a minimum number of roundabout scenarios in testing, or to otherwise evaluate some coverage metric defined with respect to map annotations.

HD maps may be manually annotated with the desired road structure. However, manual annotation is burdensome and time consuming, and prone to human error, particularly for large and complex road networks.

Herein, mechanisms for automated or semi-automated map annotation are provided. Such techniques may be used as an alternative to manual annotation, or to supplement manual annotation.

A first aspect herein is directed to a computer-implemented method of generating road annotation data for annotating an electronic map, the method comprising: accessing from persistent storage an electronic map defining a road network; generating a road topology graph encoding a topology of the road network, the road topology graph comprising nodes representing road structure elements and edges representing links between road structure elements; performing a search of the road topology graph for a predetermined graph structure; responsive to identifying a subgraph of the road topology graph exhibiting the predetermined graph structure, generating annotation data for marking in the electronic map a portion of the road network corresponding to the subgraph; and generating in persistent storage an augmented map comprising map data defining the portion of the road network and the annotation data.

In embodiments, the predetermined graph structure may be a closed loop structure, and the subgraph may comprise a plurality of nodes and a plurality of drivable links therebetween identified as forming a closed loop within the road topology graph.

The predetermined graph structure may be a one-way closed loop structure, the closed loop identified as being drivable in one direction only, and the map annotation data may identify the portion of the road network as a roundabout.

Performing the search of the road topology graph for the predetermined graph structure may comprise performing a first search in the road topology graph for closed loops which do not exceed a first loop length threshold, and performing a second search for closed loops which do not exceed a second loop length threshold greater than the first loop length threshold, excluding any road structure element belonging to any loop found in the first search.

Performing the search of the road topology graph may comprise performing a third search for closed loops which do not exceed a third loop length threshold greater than the second loop length threshold, excluding any road structure element belonging to any loop found in the first or second search.

Each node may comprise a distance cost, and a total length of a sequence of nodes is may be determined by summing their distance costs.

Any nodes representing road structure elements that are determined to be not one-way in or prior to the first search are excluded from the second search.

That is, ‘ineligible’ nodes may, for example, be excluded from subsequent searches(s) as they are encountered in a given search, or an initial pruning step may be performed to exclude them (and their links) from the road topology graph altogether.

The first and second searches may be restricted to loops commencing at a road structure element belonging to a junction.

Generating the annotation data may comprise identifying one or more junctions containing a plurality of road structure elements represented by the plurality of nodes of the subgraph. The portion of the road structure may comprise the one or more junctions and the annotation data may comprise a junction group associated with the one or more junctions.

The one or more junctions may contain at least one additional road structure element that is not represented by any node of the subgraph.

For example, the additional road structure element might be a exit or entrance road or lane to a roundabout. In identifying a closed, one-way loop or road structure elements (e.g. roads or lanes), and identifying any junction(s) which those road elements below, any additional road elements will be included in the annotated portion of the road network (as the annotation is defined at the junction-level in this example).

In general, a road structure element can be any element of the road network (e.g. a road, road section, lane, lane group etc.). In some implementations, the road topology graph is defined at the road level, meaning the nodes of the road topology graph represent roads.

The road topology graph may be generated in processor memory.

The method may further comprise rendering the road network on a graphical user interface (GUI), with a visual indicator marking the portion of the road network corresponding to the identified subgraph based on the annotation data.

The step of performing a search of the road topology graph may be taken in response to receiving a user selection of a selectable element on the graphical user interface.

Generating the augmented map may comprise augmenting the electronic map with the annotation data by generating or modifying in the electronic map at least one of a syntax element or an attribute pertaining to the portion of the road network corresponding to the identified subgraph.

For example, the annotation data may characterize the portion of the road network as a junction group, or a particular type of junction group. In that case, the map may be augmented by adding a new junction group element (one example of a syntax element) to the map, or modifying or adding a type attribute of/to an existing junction group (e.g. changing its type to ‘roundabout’).

The annotation data may comprise a wrapper element (e.g. a junction group that ‘wraps’ one or more junctions, or some other grouping element that can be used to group existing road structure elements together) assigned to the portion of the road network corresponding to the identified subgraph.

For the purpose of identifying one-way drivable loops, the road topology graph may be constructed to that each road structure element of the road topology graph comprises: a road having a start and an end, and a direction indicator indicating a either direction towards the start of the road or towards the end of the road, where each link is between a source road structure element and a destination road structure element, and indicates that traffic travelling on the road of the source road structure element in the direction indicated by the source road element could proceed onward to the road of the destination road structure element in the direction indicated by the destination road structure element.

In this context, roads with multiple driving directions (and their links) may, for example, be excluded in an initial pruning step. Road may be excluded based on additional or alternative criteria. For example, if the aim is to add junction group elements without modifying any existing junction group elements, then any road belonging to a junction that already belongs to a junction group may be excluded altogether.

Further aspects herein provide a computer system comprising one or more computers programmed or otherwise configured to implement the above method or any embodiment thereof, and a computer program product configured to program a computer system to implement the same.

In embodiments, the one or more computers may be programmed or otherwise configured to implement: a simulator configured to run a test scenario on the road network, with a dynamic agent controlled by a robotic planner under testing; and a test oracle configured to select at least one performance evaluation rule based on the annotation data, evaluate performance of the dynamic agent based on the at least one performance evaluation rule, and output a test result for the robotic planner under testing.

### BRIEF DESCRIPTION OF FIGURES

For a better understanding of the present disclosure, and to show how embodiments of the same may be carried into effect, reference is made by way of example only to the following figures in which:

FIG. 1A shows a schematic function block diagram of an autonomous vehicle stack;

FIG. 1B shows a schematic overview of an autonomous vehicle testing paradigm;

FIG. 1C shows a schematic block diagram of a scenario extraction pipeline;

FIG. 2 shows a schematic block diagram of a testing pipeline;

FIG. 3A shows a schematic block diagram of a visualization component for rendering a graphical user interface on which test results are displayed;

FIG. 3B shows a view available within a graphical user interface;

FIG. 4 shows a schematic block diagram of a scenario access system;

FIG. 4A shows an example a set of spatial indexes supporting a scenario query engine;

FIG. 5 shows an example road network;

FIG. 6 shows part of a road network annotated with OpenDRIVE elements used to describe the road network;

FIG. 7 shows an in-memory lane graph extracted from a static road layout;

FIG. 8 shows part of a lane graph with associated edge costs;

FIG. 9 shows an exemplary section of a static layer comprising a network of road structure elements that form a roundabout;

FIG. 10 shows a flow chart that illustrates a method of detecting instances of roundabouts in a static layer and annotating the static layer to identify the roundabout instances therein;

FIG. 10a shows an exemplary roundabout structure, comprising additional road structure elements which may not be identified by a loop query.

FIG. 11a illustrates a complex road structure comprising three distinct loops that share road structure elements;

FIG. 11b shows three instances of the same complex road structure as in FIG. 11a, wherein the three instances illustrate progressive steps of an exemplary roundabout identification method;

FIG. 12a shows a first instance of a user interface that displays a map that comprises a plurality of roundabouts; and

FIG. 12b shows a second instance of the user interface of FIG. 12a, wherein a roundabout detection and annotation tool has been applied to visually identify roundabout instances on the user interface.

### DETAILED DESCRIPTION

A map annotation tool is described, which automatically detects and annotates predetermined types of road structure in road layout maps. A road topology graph is extracted, which encodes a driving topology of the road layout. A predetermined type of road structure (such as a roundabout) is detected by searching for any subgraph within the driving topology graph satisfying one or more criteria (such as a one-way loop). A roundabout detection method based on one-way driving loops is described. The principles can be extended to other forms of road structure. For example, another form of search may be implemented as a graph isomorphism (locating a subgraph that is isomorphic to some indicated graph structure).

A lane graph is described, which is a graph encoding a road topology at the level of individual lanes (or ‘side-lanes’, as referred to herein), where each node represents a side-lane and edges in the graph represent links between side-lanes. One implementation of the map annotation tool operates on the lane graph, which is appropriate for identifying more ‘granular’ road structures defined in terms of side-lane topology. Another implementation uses a ‘coarser’ road topology graph, e.g., where nodes represent roads and edges represent links between road, which is appropriate for less granular road structure, e.g., roundabouts defined at the level of road (rather than lane) interconnections.

Before the annotation tool is described, the following description introduces methods for encoding a static layer of a road network, and describes methods for efficiently querying such driving scenes. An example autonomous vehicle stack is also described to provide further context.

A scenario query engine (SQE) is now described, which allows efficient geometric and topological querying of a static road layout. The static road layout may for example be formulated in OpenDRIVE or some other schema. Both geometric and topological queries return results in a form that can be interpreted in the context of the original road layout description. OpenDRIVE is intended to be mainly optimized for processing “on the wire”. To a degree, the schema seeks to avoid duplication of information (although this is by no means a hard-and-fast rule). All-in-all, the construction of the OpenDRIVE schema is not well-suited to certain forms of querying, rendering certain applications of OpenDRIVE seemingly impractical. The SQE addresses these issues as described below, which opens up new practical applications of OpenDRIVE and similar schemas.

The described techniques have both “online” and “offline” applications in autonomous driving.

An online (or “runtime”) application refers to an implementation within an autonomous vehicle stack to support autonomous planning or other decision-making functions (such as motion planning, motion prediction, route planning etc.). In an online context, a planner is required to plan driving actions for a given scenario, responding to changes in the scenario in real-time.

An offline application refers to other forms of applications, for example as part of a set of tools to support the development, testing and/or training of AV systems. By way of example, a testing pipeline is described below for assessing driving performance in real or simulated scenarios. Performance can include different facets of safety, comfort or progress towards some defined goal.

Whether real or simulated, a scenario requires an ego agent to navigate a real or modelled physical context. The ego agent is a real or simulated mobile robot that moves under the control of the stack under testing. The physical context includes static and/or dynamic element(s) that the stack under testing is required to respond to effectively. For example, the mobile robot may be a fully or semi-autonomous vehicle under the control of the stack (the ego vehicle). The physical context may comprise a static road layout and a given set of environmental conditions (e.g. weather, time of day, lighting conditions, humidity, pollution/particulate level etc.) that could be maintained or varied as the scenario progresses. A dynamic scenario additionally includes one or more other agents (“external” agent(s), e.g. other vehicles, pedestrians, cyclists, animals etc.).

In an offline simulation context, a scenario description is provided to an offline simulator as input, in order to expose a stack under testing to a simulated scenario. In an online context, a perception system may be used to generate a scenario description that can be used as a basis for higher-level functions, such as motion prediction and planning, which might involve some form of online simulation to simulate possible futures and plan accordingly.

A scenario description may be encoded using a scenario description language (SDL), or in any other form that can be consumed by whichever component(s) require it. As briefly discussed, the ASAM OpenDRIVE® standard defines a storage format for the static description of road networks and OpenSCENARIO® may be used to add dynamic content. Other forms of scenario description may be used, including bespoke languages and formats, and the present techniques are not limited to any particular SDL, storage format, schema or standard.

A “scenario run” or “scenario instance” refers to a concrete occurrence of an agent(s) navigating a physical context, optionally in the presence of one or more other agents. A single scenario description can give rise to multiple simulated runs, with different outcomes, not least because those outcomes depend on decisions taken by the stack under testing. The terms “run” and “instance” are used interchangeably in this context.

### Example AV Stack

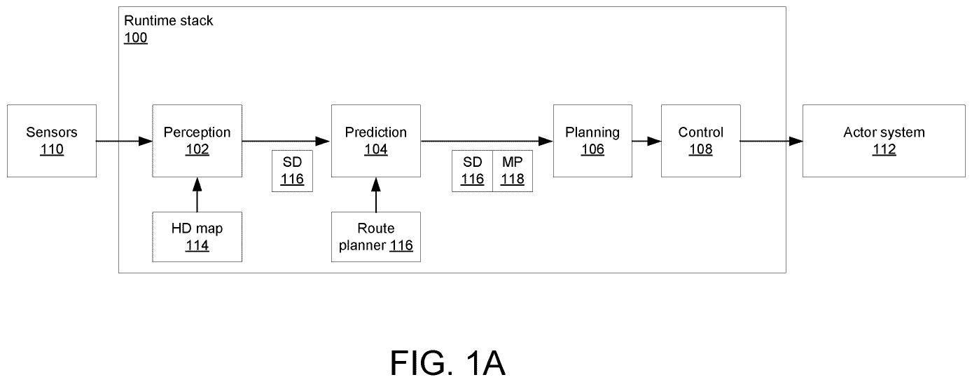

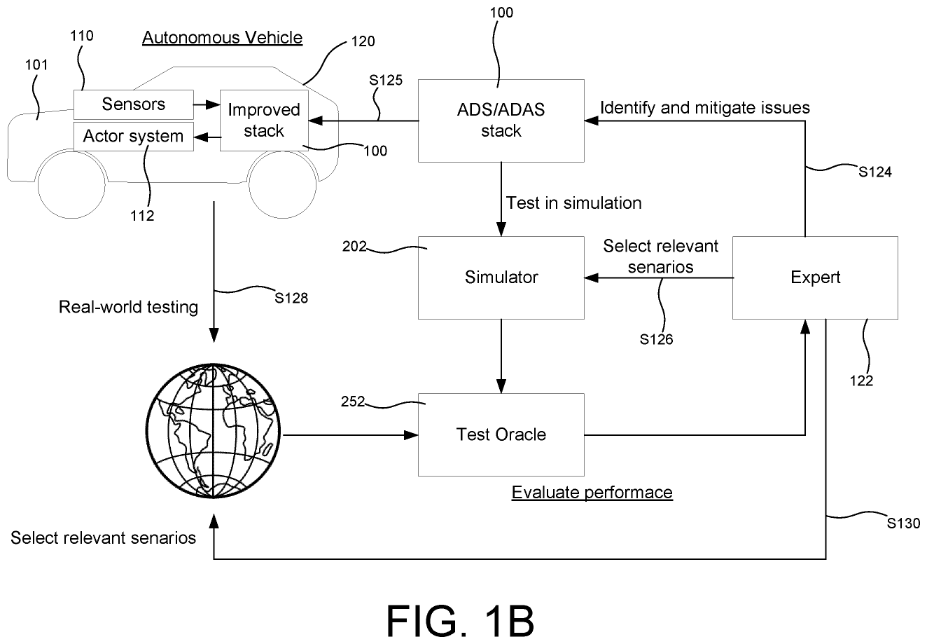

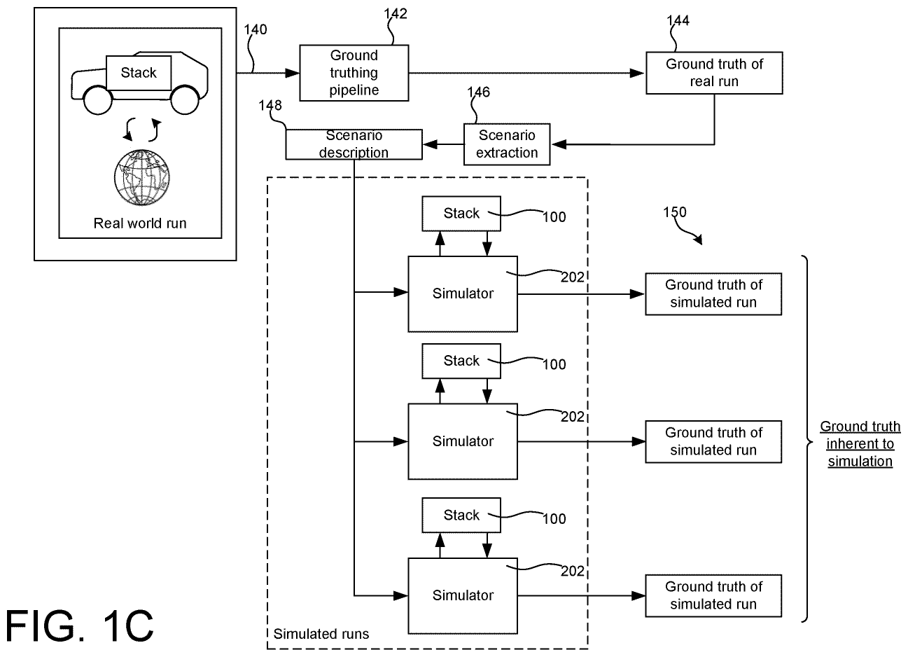

FIG. 1A shows a highly schematic block diagram of an AV runtime stack 100. The stack 100 may be fully or semi-autonomous. For example, the stack 100 may operate as an Autonomous Driving System (ADS) or Advanced Driver Assist System (ADAS).

The run time stack 100 is shown to comprise a perception (sub-) system 102, a prediction (sub-) system 104, a planning (sub-) system (planner) 106 and a control (sub-) system (controller) 108.

In a real-world context, the perception system 102 receives sensor outputs from an on-board sensor system 110 of the AV, and uses those sensor outputs to detect external agents and measure their physical state, such as their position, velocity, acceleration etc. The on-board sensor system 110 can take different forms but generally comprises a variety of sensors such as image capture devices (cameras/optical sensors), lidar and/or radar unit(s), satellite-positioning sensor(s) (GPS etc.), motion/inertial sensor(s) (accelerometers, gyroscopes etc.) etc. The onboard sensor system 110 thus provides rich sensor data from which it is possible to extract detailed information about the surrounding environment, and the state of the AV and any external actors (vehicles, pedestrians, cyclists etc.) within that environment. The sensor outputs typically comprise sensor data of multiple sensor modalities such as stereo images from one or more stereo optical sensors, lidar, radar etc. Sensor data of multiple sensor modalities may be combined using filters, fusion components etc.

The perception system 102 typically comprises multiple perception components which co-operate to interpret the sensor outputs and thereby provide perception outputs to the prediction system 104.

In a simulation context, depending on the nature of the testing—and depending, in particular, on where the stack 100 is “sliced” for the purpose of testing (see below)—it may or may not be necessary to model the on-board sensor system 100. With higher-level slicing, simulated sensor data is not required therefore complex sensor modelling is not required.

The perception outputs from the perception system 102 are used by the prediction system 104 to predict future behaviour of external actors (agents), such as other vehicles in the vicinity of the AV.

Predictions computed by the prediction system 104 are provided to the planner 106, which uses the predictions to make autonomous driving decisions to be executed by the AV in a given driving scenario. The inputs received by the planner 106 would typically indicate a drivable area and would also capture predicted movements of any external agents (obstacles, from the AV's perspective) within the drivable area. The driveable area can be determined using perception outputs from the perception system 102 in combination with map information, such as an HD (high definition) map.

A core function of the planner 106 is the planning of trajectories for the AV (ego trajectories), taking into account predicted agent motion. This may be referred to as trajectory planning. A trajectory is planned in order to carry out a desired goal within a scenario. The goal could for example be to enter a roundabout and leave it at a desired exit; to overtake a vehicle in front; or to stay in a current lane at a target speed (lane following). The goal may, for example, be determined by an autonomous route planner 116, also referred to as a goal generator 116.

The controller 108 executes the decisions taken by the planner 106 by providing suitable control signals to an on-board actor system 112 of the AV. In particular, the planner 106 plans trajectories for the AV and the controller 108 generates control signals to implement the planned trajectories. Typically, the planner 106 will plan into the future, such that a planned trajectory may only be partially implemented at the control level before a new trajectory is planned by the planner 106. The actor system 112 includes “primary” vehicle systems, such as braking, acceleration and steering systems, as well as secondary systems (e.g. signalling, wipers, headlights etc.).

The example of FIG. 1A considers a relatively “modular” architecture, with separable perception, prediction, planning and control systems 102-108. The sub-stack themselves may also be modular, e.g. with separable planning modules within the planning system 106. For example, the planning system 106 may comprise multiple trajectory planning modules that can be applied in different physical contexts (e.g. simple lane driving vs. complex junctions or roundabouts). This is relevant to simulation testing for the reasons noted above, as it allows components (such as the planning system 106 or individual planning modules thereof) to be tested individually or in different combinations. For the avoidance of doubt, with modular stack architectures, the term stack can refer not only to the full stack but to any individual sub-system or module thereof.

The extent to which the various stack functions are integrated or separable can vary significantly between different stack implementations—in some stacks, certain aspects may be so tightly coupled as to be indistinguishable. For example, in other stacks, planning and control may be integrated (e.g. such stacks could plan in terms of control signals directly), whereas other stacks (such as that depicted in FIG. 1A) may be architected in a way that draws a clear distinction between the two (e.g. with planning in terms of trajectories, and with separate control optimizations to determine how best to execute a planned trajectory at the control signal level). Similarly, in some stacks, prediction and planning may be more tightly coupled. At the extreme, in so-called “end-to-end” driving, perception, prediction, planning and control may be essentially inseparable. Unless otherwise indicated, the perception, prediction planning and control terminology used herein does not imply any particular coupling or modularity of those aspects.

A “full” stack typically involves everything from processing and interpretation of low-level sensor data (perception), feeding into primary higher-level functions such as prediction and planning, as well as control logic to generate suitable control signals to implement planning-level decisions (e.g. to control braking, steering, acceleration etc.). For autonomous vehicles, level 3 stacks include some logic to implement transition demands and level 4 stacks additionally include some logic for implementing minimum risk maneuvers. The stack may also implement secondary control functions e.g. of signalling, headlights, windscreen wipers etc.

The term “stack” can also refer to individual sub-systems (sub-stacks) of the full stack, such as perception, prediction, planning or control stacks 104, 106, 108, which may be tested individually or in any desired combination. A stack can refer purely to software, i.e. one or more computer programs that can be executed on one or more general-purpose computer processors. It will be appreciated that the term “stack” encompasses software, but can also encompass hardware. In simulation, software of the stack may be tested on a “generic” off-board computer system, before it is eventually uploaded to an on-board computer system of a physical vehicle. However, in “hardware-in-the-loop” testing, the testing may extend to underlying hardware of the vehicle itself. For example, the stack software may be run on the on-board computer system (or a replica thereof) that is coupled to the simulator for the purpose of testing. In this context, the stack under testing extends to the underlying computer hardware of the vehicle. As another example, certain functions of the stack 110 (e.g. perception functions) may be implemented in dedicated hardware. In a simulation context, hardware-in-the loop testing could involve feeding synthetic sensor data to dedicated hardware perception components.

Within the stack 100, a scenario description 116 may be used as a basis for planning and prediction. The scenario description 116 is generated using the perception system 102, together with a high-definition (HD) road layout map 114. By localizing the ego vehicle 114 on the map, it is possible to combine the information extracted in the perception system 104 (including dynamic agent information) with the pre-existing environmental information contained in the HD map 114. The scenario description 116 is, in turn, used as a basis for motion prediction in the prediction system 104, and the resulting motion predictions 118 are used in combination with the scenario description 116 as a basis for planning in the planning system 106.

The stack 100 can make use of any annotations contained in or otherwise associated with the map 114. For example, on approaching a set of junctions marked as a roundabout, the prediction component 104 and planner 106 may engage roundabout-specific prediction and planning functions in response. In this case, AV functions (such as planning or predictions) are dependent on map annotations.

### Example Testing Paradigm

FIG. 1B shows a highly schematic overview of a testing paradigm for autonomous vehicles. An ADS/ADAS stack 100, e.g. of the kind depicted in FIG. 1A, is subject to repeated testing and evaluation in simulation, by running multiple scenario instances in a simulator 202, and evaluating the performance of the stack 100 (and/or individual subs-stacks thereof) in a test oracle 252. The output of the test oracle 252 is informative to an expert 122 (team or individual), allowing them to identify issues in the stack 100 and modify the stack 100 to mitigate those issues (S124). The results also assist the expert 122 in selecting further scenarios for testing (S126), and the process continues, repeatedly modifying, testing and evaluating the performance of the stack 100 in simulation. The improved stack 100 is eventually incorporated (S125) in a real-world AV 101, equipped with a sensor system 110 and an actor system 112. The improved stack 100 typically includes program instructions (software) executed in one or more computer processors of an on-board computer system of the vehicle 101 (not shown). The software of the improved stack is uploaded to the AV 101 at step S125. Step S125 may also involve modifications to the underlying vehicle hardware. On board the AV 101, the improved stack 100 receives sensor data from the sensor system 110 and outputs control signals to the actor system 112. Real-world testing (S128) can be used in combination with simulation-based testing. For example, having reached an acceptable level of performance through the process of simulation testing and stack refinement, appropriate real-world scenarios may be selected (S130), and the performance of the AV 101 in those real scenarios may be captured and similarly evaluated in the test oracle 252.

Scenarios can be obtained for the purpose of simulation in various ways, including manual encoding. The system is also capable of extracting scenarios for the purpose of simulation from real-world runs, allowing real-world situations and variations thereof to be re-created in the simulator 202.

FIG. 1C shows a highly schematic block diagram of a scenario extraction pipeline. Data 140 of a real-world run is passed to a ‘ground-truthing’ pipeline 142 for the purpose of generating scenario ground truth. The run data 140 could comprise, for example, sensor data and/or perception outputs captured/generated on board one or more vehicles (which could be autonomous, human-driven or a combination thereof), and/or data captured from other sources such external sensors (CCTV etc.). The run data is processed within the ground truthing pipeline 142, in order to generate appropriate ground truth 144 (“trace(s)” and contextual data) for the real-world run. The ground-truthing process could be based on manual annotation of the ‘raw’ run data 140, or the process could be entirely automated (e.g. using offline perception method(s)), or a combination of manual and automated ground truthing could be used. For example, 3D bounding boxes may be placed around vehicles and/or other agents captured in the run data 140, in order to determine spatial and motion states of their traces. A scenario extraction component 146 receives the scenario ground truth 144, and processes the scenario ground truth 144 to extract a scenario description 148 that can be used for the purpose of simulation. The scenario description 148 is consumed by the simulator 202, allowing multiple simulated runs to be derived therefrom. Ground truth 150 is provided for each simulated run.

A “trace” is a history of an agent's location and motion over the course of a scenario. There are many ways a trace can be represented. Trace data will typically include spatial and motion data of an agent within the environment. The term is used in relation to both real scenarios (with real-world traces) and simulated scenarios (with simulated traces).

The term “perception” generally refers to techniques for perceiving structure in the real-world data 140, such as 2D or 3D bounding box detection, location detection, pose detection, motion detection etc. For example, a trace may be extracted as a time-series of bounding boxes or other spatial states in 3D space or 2D space (e.g. in a birds-eye-view frame of reference), with associated motion information (e.g. speed, acceleration, jerk etc.). In the context of image processing, such techniques are often classed as “computer vision”, but the term perception encompasses a broader range of sensor modalities.

### Testing Pipeline

Further details of an example testing pipeline incorporating the test oracle 252 will now be described. The examples that follow focus on simulation-based testing. However, as noted, the test oracle 252 can equally be applied to evaluate stack performance on real scenarios, and the relevant description below applies equally to real scenarios. The following description refers to the stack 100 of FIG. 1A by way of example. However, as noted, the testing pipeline 200 is highly flexible and can be applied to any stack or sub-stack operating at any level of autonomy.

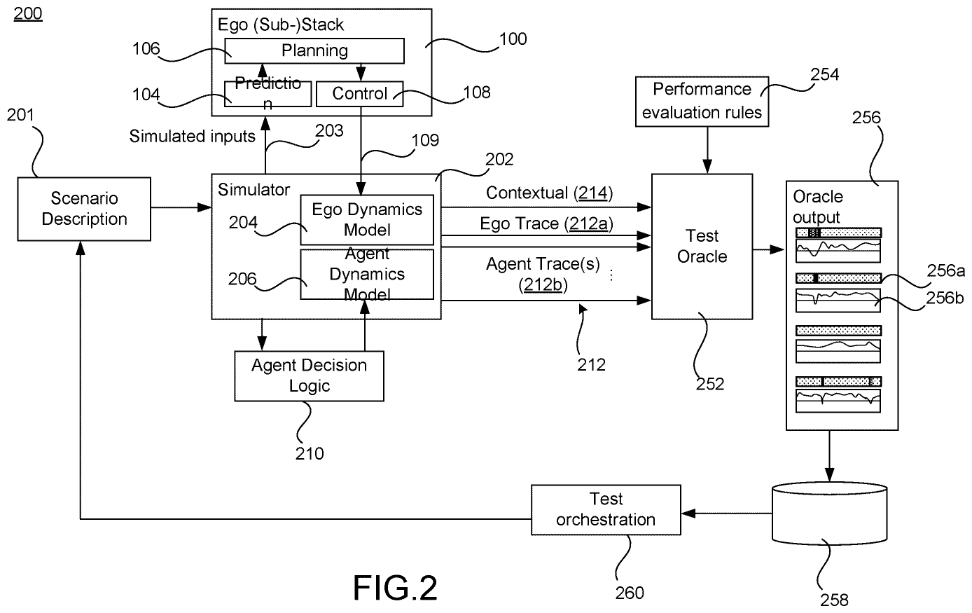

FIG. 2 shows a schematic block diagram of the testing pipeline, denoted by reference numeral 200. The testing pipeline 200 is shown to comprise the simulator 202 and the test oracle 252. The simulator 202 runs simulated scenarios for the purpose of testing all or part of an AV run time stack 100, and the test oracle 252 evaluates the performance of the stack (or sub-stack) on the simulated scenarios. As discussed, it may be that only a sub-stack of the run-time stack is tested, but for simplicity, the following description refers to the (full) AV stack 100 throughout. However, the description applies equally to a sub-stack in place of the full stack 100. The term “slicing” is used herein to the selection of a set or subset of stack components for testing.

The idea of simulation-based testing is to run a simulated driving scenario that an ego agent must navigate under the control of the stack 100 being tested. Typically, the scenario includes a static drivable area (e.g. a particular static road layout) that the ego agent is required to navigate, typically in the presence of one or more other dynamic agents (such as other vehicles, bicycles, pedestrians etc.). To this end, simulated inputs 203 are provided from the simulator 202 to the stack 100 under testing.

The slicing of the stack dictates the form of the simulated inputs 203. By way of example, FIG. 2 shows the prediction, planning and control systems 104, 106 and 108 within the AV stack 100 being tested. To test the full AV stack of FIG. 1A, the perception system 102 could also be applied during testing. In this case, the simulated inputs 203 would comprise synthetic sensor data that is generated using appropriate sensor model(s) and processed within the perception system 102 in the same way as real sensor data. This requires the generation of sufficiently realistic synthetic sensor inputs (such as photorealistic image data and/or equally realistic simulated lidar/radar data etc.). The resulting outputs of the perception system 102 would, in turn, feed into the higher-level prediction and planning systems 104, 106.

By contrast, so-called “planning-level” simulation would essentially bypass the perception system 102. The simulator 202 would instead provide simpler, higher-level inputs 203 directly to the prediction system 104. In some contexts, it may even be appropriate to bypass the prediction system 104 as well, in order to test the planner 106 on predictions obtained directly from the simulated scenario (i.e. “perfect” predictions).

Between these extremes, there is scope for many different levels of input slicing, e.g. testing only a subset of the perception system 102, such as “later” (higher-level) perception components, e.g. components such as filters or fusion components which operate on the outputs from lower-level perception components (such as object detectors, bounding box detectors, motion detectors etc.).

As an alternative to synthetic sensor data, all or part of the perception system 102 may be modelled, e.g. using one or more perception error models to introduce realistic error into the simulated inputs 203. For example, Perception Statistical Performance Models (PSPMs) or, synonymously, “PRISMs” may be used. Further details of the principles of PSPMs, and suitable techniques for building and training such models, may be bound in International Patent Publication Nos. WO2021037763 WO2021037760, WO2021037765, WO2021037761, and WO2021037766, each of which is incorporated herein by reference in its entirety.

Whatever form they take, the simulated inputs 203 are used (directly or indirectly) as a basis for decision-making by the planner 108. The controller 108, in turn, implements the planner's decisions by outputting control signals 109. In a real-world context, these control signals would drive the physical actor system 112 of AV. In simulation, an ego vehicle dynamics model 204 is used to translate the resulting control signals 109 into realistic motion of the ego agent within the simulation, thereby simulating the physical response of an autonomous vehicle to the control signals 109.

Alternatively, a simpler form of simulation assumes that the ego agent follows each planned trajectory exactly between planning steps. This approach bypasses the control system 108 (to the extent it is separable from planning) and removes the need for the ego vehicle dynamic model 204. This may be sufficient for testing certain facets of planning.

To the extent that external agents exhibit autonomous behaviour/decision making within the simulator 202, some form of agent decision logic 210 is implemented to carry out those decisions and determine agent behaviour within the scenario. The agent decision logic 210 may be comparable in complexity to the ego stack 100 itself or it may have a more limited decision-making capability. The aim is to provide sufficiently realistic external agent behaviour within the simulator 202 to be able to usefully test the decision-making capabilities of the ego stack 100. In some contexts, this does not require any agent decision making logic 210 at all (open-loop simulation), and in other contexts useful testing can be provided using relatively limited agent logic 210 such as basic adaptive cruise control (ACC). One or more agent dynamics models 206 may be used to provide more realistic agent behaviour if appropriate.

A scenario is run in accordance with a scenario description 201, which typically has both static and dynamic elements. The static element(s) typically include a static road layout. The dynamic element(s) typically include one or more external agents within the scenario, such as other vehicles, pedestrians, bicycles etc. Scenario runs are orchestrated by a test orchestration component 260.

The extent of the dynamic information provided to the simulator 202 for each external agent can vary. For example, a scenario may be described by separable static and dynamic layers. A given static layer (e.g. defining a road layout) can be used in combination with different dynamic layers to provide different scenario instances. The dynamic layer may comprise, for each external agent, a spatial path to be followed by the agent together with one or both of motion data and behaviour data associated with the path. In simple open-loop simulation, an external actor simply follows the spatial path and motion data defined in the dynamic layer that is non-reactive i.e. does not react to the ego agent within the simulation. Such open-loop simulation can be implemented without any agent decision logic 210. However, in closed-loop simulation, the dynamic layer instead defines at least one behaviour to be followed along a static path (such as an ACC behaviour). In this case, the agent decision logic 210 implements that behaviour within the simulation in a reactive manner, i.e. reactive to the ego agent and/or other external agent(s). Motion data may still be associated with the static path but in this case is less prescriptive and may for example serve as a target along the path. For example, with an ACC behaviour, target speeds may be set along the path which the agent will seek to match, but the agent decision logic 210 might be permitted to reduce the speed of the external agent below the target at any point along the path in order to maintain a target headway from a forward vehicle.

The output of the simulator 202 for a given simulation includes an ego trace 212a of the ego agent and one or more agent traces 212b of the one or more external agents (traces 212). Each trace 212a, 212b is a complete history of an agent's behaviour within a simulation having both spatial and motion components. For example, each trace 212a, 212b may take the form of a spatial path having motion data associated with points along the path such as speed, acceleration, jerk (rate of change of acceleration), snap (rate of change of jerk) etc.

Additional information is also provided to supplement and provide context to the traces 212. Such additional information is referred to as “contextual” data 214. The contextual data 214 pertains to the physical context of the scenario, and can have both static components (such as road layout) and dynamic components (such as weather conditions to the extent they vary over the course of the simulation).

The test oracle 252 receives the traces 212 and the contextual data 214, and scores those outputs in respect of a set of performance evaluation rules 254. The performance evaluation rules 254 are shown to be provided as an input to the test oracle 252.

The rules 254 are categorical in nature (e.g. pass/fail-type rules). Certain performance evaluation rules are also associated with numerical performance metrics used to “score” trajectories (e.g. indicating a degree of success or failure or some other quantity that helps explain or is otherwise relevant to the categorical results). The evaluation of the rules 254 is time-based-a given rule may have a different outcome at different points in the scenario. The scoring is also time-based: for each performance evaluation metric, the test oracle 252 tracks how the value of that metric (the score) changes over time as the simulation progresses. The test oracle 252 provides an output 256 comprising a time sequence 256a of categorical (e.g. pass/fail) results for each rule, and a score-time plot 256b for each performance metric, as described in further detail later. The results and scores 256a, 256b are informative to the expert 122 and can be used to identify and mitigate performance issues within the tested stack 100. The test oracle 252 also provides an overall (aggregate) result for the scenario (e.g. overall pass/fail). The output 256 of the test oracle 252 is stored in a test database 258, in association with information about the scenario to which the output 256 pertains.

A rule set refers to a set of one or more performance evaluation rules applied by the test oracle 252. A rule set may be selected in a context-dependent manner. For example, a specific roundabout ruleset may be designed to test ego behaviour in a roundabout scenario, such as roundabout-specific road rules (e.g. rules relating to the direction of traffic flow, priority or ‘give way’ rules, rules concerning lane usage etc.). Other aspects of driving performance, such as progress, may also be assessed using specific rules, such as a rule assessing ‘missed opportunities’ to safely join a roundabout. In this context, map annotations (such as roundabout elements) govern the selection of rules in the rest oracle 252. In some implementations, different ruleset may be applied at different intervals within a test run, e.g. the test oracle 252 may switch from a lane driving rule set to a roundabout rule set when an ego agent is determined to be within some predetermined distance of a roundabout (or junction belonging to a roundabout).

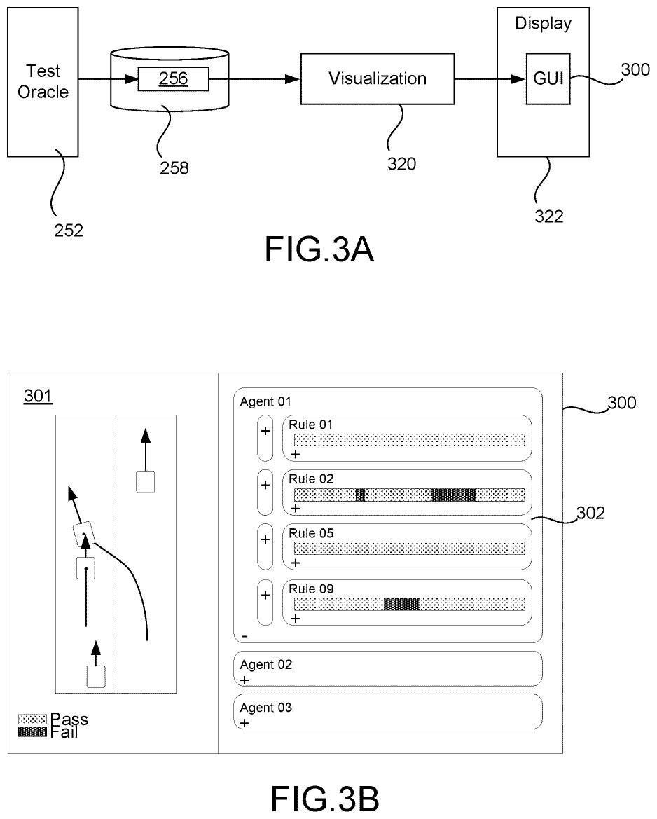

FIG. 3A shows a schematic block diagram of a visualization component 320. The visualization component 320 is shown having an input connected to the test database 258 for rendering the outputs 256 of the test oracle 252 on a graphical user interface (GUI) 300. The GUI is rendered on a display system 322.

FIG. 3B shows an example view of the GUI 300. The view pertains to a particular scenario containing multiple agents, and is shown to comprise a scenario visualization 301 and a set of driving performance assessment results 302. In this example, the test oracle output 526 pertains to multiple external agents, and the results are organized according to agent. For each agent, a time-series of results is available for each rule applicable to that agent at some point in the scenario. Colour coding is used to differentiate between periods of pass/fail on a particular rule. For a scenario with changing rule sets, different rule sets may be visualized on the GUI at different times, in a way that depends on map annotations.

### Scenario Query Engine

The scenario descriptions 116, 148, 201 described above are typically highly detailed. A high level of precision is required of the 3D road and lane geometry, typically to centimetre precision. A complex driving scenario might involve a network of roads and junction(s). It is often inefficient and time consuming to extract a required piece of information from a scenario description directly. To this end, a scenario query engine is provided, which allows fast processing of structured queries to be performed on a driving scenario description. The scenario query engine has many applications, including online applications of the kind depicted in FIG. 1A and offline applications of the kind depicted in FIGS. 1C and 2.

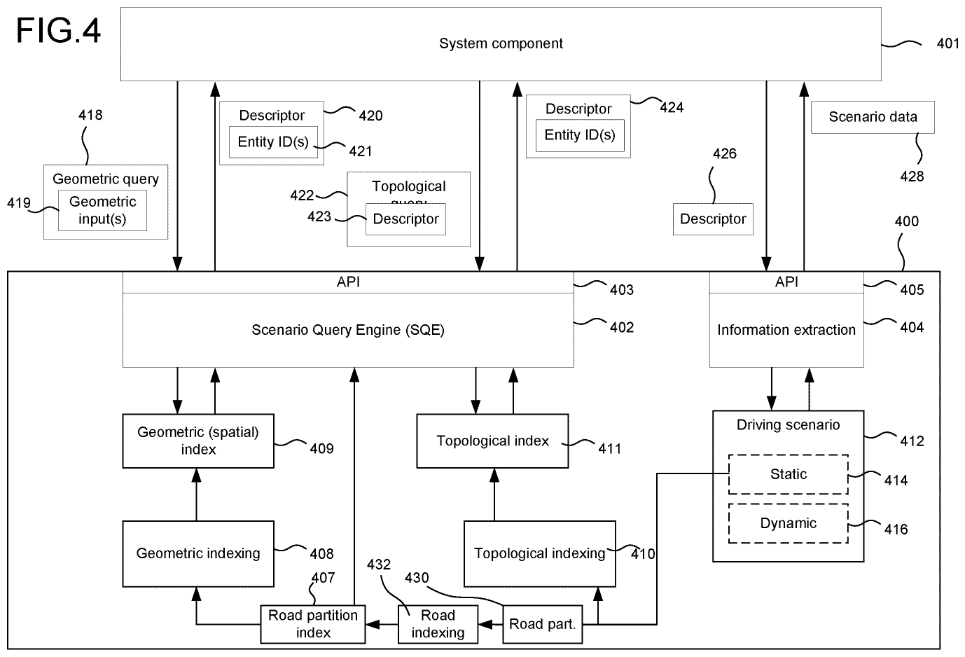

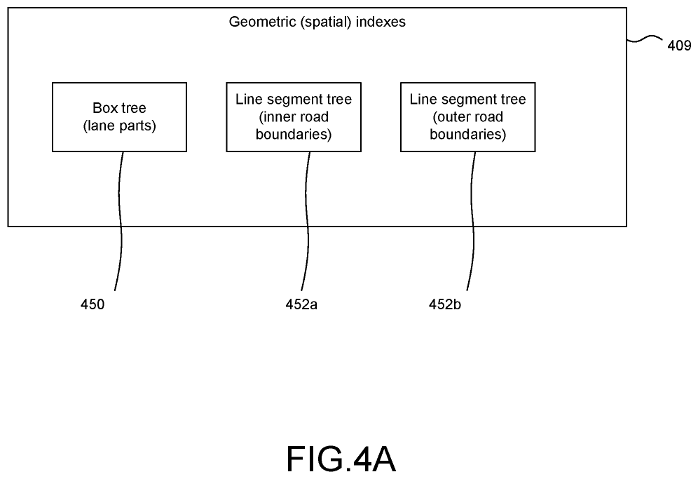

FIG. 4 shows a schematic block diagram of a scenario access system 400. The scenario access system 400 provides optimized information retrieval on behalf of other system components that require access to a driving scenario description 412.

The scenario description 412 is shown to have both static and dynamic layers 414, 416. In this example, the static layer 414 is encoded in a specification (document) that conforms to the OpenDRIVE schema, or some variant of OpenDRIVE (or other structured scenario description format), and the dynamic layer 416 is encoded using OpenSCENARIO.

The scenario access system is shown to comprise a scenario query engine (SQE) 402 and an extraction component 404. The SQE 402 is called via a first application programming interface (403) and the information extraction component 404 is called via a second API 405.

The first API 403 provides a set of scenario query functions that can be flexibly combined to perform complex queries on the driving scenario 412, and the second API 405 provides a set of information extraction functions for selectively extracting information from the driving scenario 412. A system component 401 built on top of the APIs 403, 405 is depicted. Different system components can be built on the APIs 403, 405 in this manner, reducing the burden on software developers. The system component 401 could, for example, be a component of the online stack 100 (such as the planning or prediction system 104, 106, or some component thereof) or an offline component (such as the simulator 202 within the testing pipeline 200).

The SQE 402 accepts both “geometric” and “topological” queries on the scenario description 412. Various scenario query functions provide results in the form of “descriptors” that allow information to be located in the underlying scenario description 412. The following examples consider geometric and topological queries on the static layer 414.

A geometric query 418 indicates one or more geometric constraints 419 (geometric inputs), and returns a response 420 in the form of a descriptor that identifies one or more road structure elements that satisfy the geometric constraints 419.

A descriptor comprises an identifier of each road structure entity that allows the corresponding section of the static layer 412 (that is, the section describing that road structure element) to be located (denoted by reference numeral 421 for the descriptor 420). A descriptor may contain additional information about the road structure element(s) satisfying the query. For example, the geometric inputs 419 might define a point or box (rectangle), and the response might indicate any road structure element(s) that intersect that point or box.

To facilitate geometric queries, a geometric indexing component 408 is provided. The geometric indexing component 408 builds a geometric (spatial) index 409 of the static layer 414 of the scenario description 412. The geometric index 409 is an in-memory data structure that maps geometric inputs to corresponding road structure elements within the scenario description 412. In the following examples, “roads” and “lanes” are the main types of road element considered. As described in further detail below, in OpenDRIVE, roads are described in terms of <road> elements and lanes are described in terms of <lane> elements. Although a single geometric index 409 is depicted, separate geometric indexes may be provided for different types of road structure element, for example separate spatial indexes for road and lanes.

To support efficient geometric querying, novel “road part” and “lane part” concepts are introduced. These concepts and their manner of utilization are described in Table 1 below.

The geometric index 409 is two-dimensional (2D), defined in a birds-eye-view plane of the road network. The static layer 414 may be 3D (e.g. to describe varying road elevation), even when the geometric index 409 is 2D. In other implementations, the geometric index 409 is three dimensional. Three-dimensional spatial indices may be useful e.g. in addressing ambiguity inherent in a plan view associated with under/over passes (where one road passes under another, leading to ambiguity in a 2D plan view).

Whilst the geometric index 409 is depicted as a single element in FIG. 4, in the described implementations, the API 403 is supported by a collection of geometric indexes.

FIG. 4A shows multiple geometric indexes, namely a bounding box tree 450, an inner boundary line segment tree 452a and an outer boundary line segment tree 452b, each of which is described in detail below.

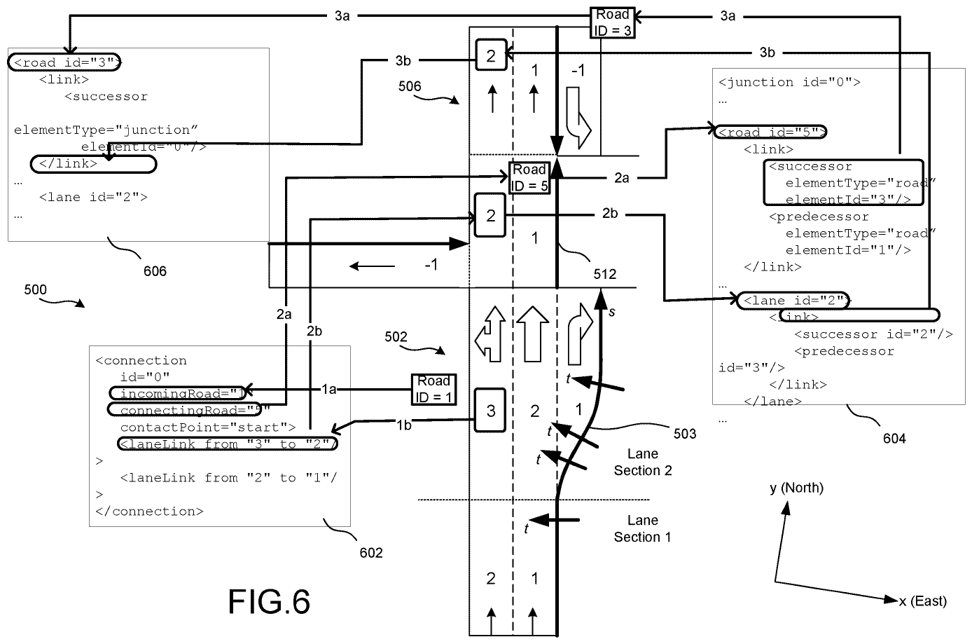

A topological query 422 includes an input descriptor 423 of one or more road structure elements (input elements), and returns a response in the form of an output descriptor 424 of one or more road structure elements (output elements) that satisfy the topological query because they have some defined topological relationship to the input elements. For example, a topological query might indicate a start lane and destination lane, and request a set of “micro routes” from the start lane to the destination lane, where a micro route is defined as a sequence of traversable lanes from the former to the latter. This is an example of what is referred to herein as “microplanning” (see FIG. 6 for further details). Different topological query types may be defined for different types of topological relationships.

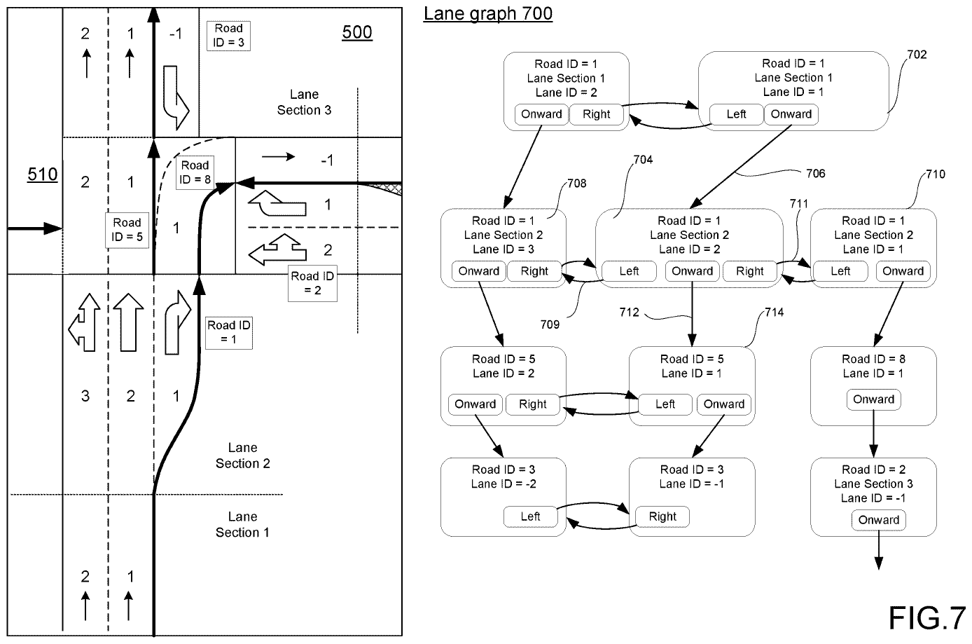

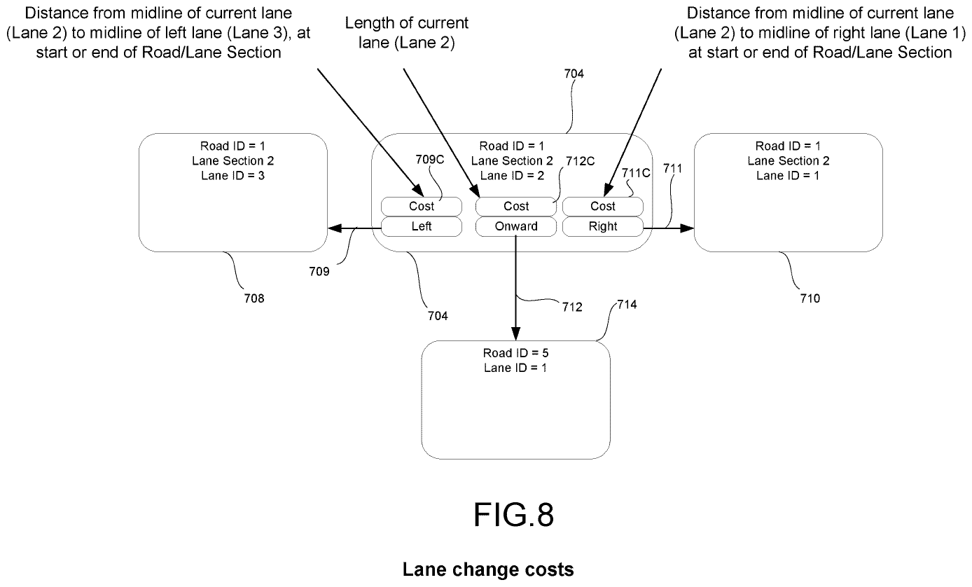

To facilitate topological queries, a topological indexing component 410 builds a topological index 411 of the static layer 414. The topological index 411 is an in-memory graph of road structure elements. Nodes of the graph encode structure elements and edges of the graph represent code topological relationships between the road structure elements. The nodes are embodied in memory as addressable memory locations and the edges as in-memory points to the corresponding memory addresses. Although a single index is depicted, in the examples below, separate topological indexes—a “road graph” and a “lane graph”—are constructed. See FIGS. 7 and 8 for further details.

The second API 426 maps information provided in a descriptor 426 to the corresponding section(s) of the scenario description 412. In response to a descriptor 426 of the static layer 416, the information extraction component 404 provides one or more pieces of scenario data 428 extracted from the corresponding section(s) of the static layer 414. For example, given a descriptor 426 indicating a particular lane, the information extraction component 404 would be able to provide, say, the 3D geometry of the lane from the static layer 414 or some associated piece of information from the dynamic layer 416 (e.g. indicating any agents whose starting locations lie within a particular road or lane).

Geometric and topological queries can be flexibility combined. For example, starting with some geometric constraint(s), a geometric query can return the description of corresponding road(s) or lane(s) (e.g. to find the lane containing the point x). The latter can then be used as the basis for a topological query (e.g. to find all lanes connected to the lane containing the point x).

Both geometric and topological queries return results in a form that can be interpreted in the context of the original static layer 414. A descriptor 420 returned on a geometric query 418 maps directly to the corresponding section(s) in the static layer 414 (e.g. a query for the lane intersecting the point x would return a descriptor that maps directly to the section describing the lane in question). The same is true of topological queries.

Whilst FIG. 4 depicts a driving scenario 412 with both static and dynamic layers 416, the techniques can be applied to a description of a static road layout with no dynamic layer.

A road partition index 407 is also shown, which is generated by a road indexing component 432 and is described in detail below. The road partition index 407 is used to build the geometric index 408, and also to support certain modes of query directly at the SQE API 403. The road indexing component 432 is supported by a road partitioning component 430, whose functionality is described below.

Certain novel concepts underpinning geometric queries within the SQE 402 are summarized in Table 1 below. The concepts are not found in the OpenDRIVE schema, and have been introduced to allow geometric queries to be constructed so that they can be processed quickly.

Table 2 summarizes the construction of the various indexes shown in FIGS. 4 and 4A.

Table 3 summarizes how these indexes are used to support certain modes of query at the SQE API 403.

Tables 1 to 3 refer to certain OpenDRIVE concepts, and further description of these OpenDRIVE concepts follows Table 3. Whilst OpenDRIVE is used as a reference point, the described techniques can be applied to other road network schemas, with the same benefits as set out herein.

TABLE 1
Summary of additional concepts.

| Concept | Description |
|---|---|
| Road part. | Applicable to road network schemas, such as OpenDRIVE, in which road/lane boundaries |
| | are encoded in terms of multiple functions that can change at arbitrary points along the |
| | road. The number of functions may also change e.g. as the number of lanes changes. A |
| | road part refers to an s-coordinate interval in which the road is described by a single fixed |
| | subset of the functions of interest. In other words, within any given road part no change |
| | occurs in any of the functions of interest along the length of the road part (and the number |
| | of functions does not change). |
| | For example, a road reference line might be defined as a straight line function (f1) on the |
| | interval [0, s2) (its support), a spiral function (f2) on the interval [s2, s3) and an arc |
| | function (f3) on the interval [s3, s5]. The interval [0, s1) could span a first lane section |
| | with a single side-lane (ID 1) of constant width (constant width function f4). At s1, a new |
| | lane section might begin with two side-lanes (ID 1 and 2), with the width of Lane 2 |
| | described by a function f5 linearly increasing from zero in the interval [s1, s4), and then |
| | by a constant width function f6 in the interval [s4, s5]. For simplicity of illustration, it is |
| | assumed that the width of Lane 1 remains constant throughout, described by f4. In this |
| | case, one viable partitioning of the road that satisfies the above requirements is: |
| | ([0, s1), [s1, s2), [s2, s3), [s3, s4), [s4, s5]). |
| Lane part. | A lane part refers to a side-lane within a road part in the above sense (an s-interval in |
| | which no function of interest changes and the number of functions does not change). A |
| | lane part may be described by a “bundle” comprising a road partition identifier (e.g. s- |
| | rage of the partition) and a lane ID. |
| | So, in the above example, there are nine lane parts in total - a single lane part being the |
| | lane with ID 1 in the interval [0, s1), with two lane parts in each of the subsequent intervals |
| | being the portions of the lanes with ID 1 and 2 respectively contained within that interval. |
| | Note the partitioning of the lanes is defined by the partitioning of the road as a whole, |
| | which in turn is defined by the supports of the full set of functions of interest. |

TABLE 2
Summary of indexes.

| | | Illustrative |
|---|---|---|
| Index | Description | FIGS. |
| Topological | A directed graph (side-lane graph) in which nodes represent side- | FIG. 7: Side-lane |
| index 411. | lanes and edges between nodes represent directed lane | graph. |
| | connections between side-lanes (which may or may not be | FIG. 8: Lane change |
| | drivable; e.g. it may be useful to find a sequence of side-lanes | costs. |
| | navigable by pedestrians). In this context, the term “lane change” | FIG. 8: Graph with |
| | is used in a broader sense, and can include not only left/right lane | bi-directional side- |
| | changes, but also “onward” lane changes from one lane to its | lane. |
| | immediate successor/predecessor (staying in lane from the | |
| | driver's perspective, whilst crossing a boundary between | |
| | connected roads/junctions/lane sections etc. of the road network). | |
| | The existence of a path through the graph from a first node to a | |
| | second node implies the existence of a drivable route from the | |
| | former to the latter, expressed as the corresponding sequence of | |
| | side-lanes (micro-route) to be driven by a vehicle. | |
| | Each edge may be associated with a cost that is representative of | |
| | driving distance incurred by the corresponding lane change. For | |
| | a left/right lane change, the cost would generally depend on | |
| | lateral distance from a current lane to its left/right neighbour. For | |
| | an onward lane change from a current lane to an onward lane, the | |
| | cost would generally depend on the length (longitudinal extent) | |
| | of the current lane (which would have to be driven to reach the | |
| | onward lane). | |
| | By and large, there is a one-to-one mapping between nodes in the | |
| | topological index and side-lanes in the underlying OpenDRIVE | |
| | layout, which is desirable to maintain a close alignment with the | |
| | underlying road network representation. Bi-directional side- | |
| | lanes are an exception to this one-to-one mapping: a bi- | |
| | directional lane is represented as two separate nodes in the | |
| | topological index, one for each driving direction. | |
| | In the described implementations, the topological index does not | |
| | leverage the road part and lane part concepts introduced above; | |
| | rather, these are only utilized in the construction and processing | |
| | of geometric queries. | |

TABLE 3
Summary of query modes.

| | Supporting | | Illustrative |
|---|---|---|---|
| Query mode | indexes | Description | FIGS. |
| Route | Topological | A query that returns a micro-route from a first | Cost-based |
| planning. | index. | specified side-lane to a second specified side-lane | search on lane |
| | | having lowest overall costs. The SQE performs a | graph of |
| | | search on the topological index to find the lowest- | FIGS. 7-8. |
| | | cost path through the tree from the node of the first | |
| | | side-lane to the node of the second-side lane. Any | |
| | | cost-based tree search can be used (a depth first | |
| | | search is used in the described implementation). | |
| | | To obtain the first and second side lanes, geometric | |
| | | queries can be used e.g. to find the side-lane | |
| | | containing a given point/box or the closest side lane | |
| | | to a given point/box. | |

For type-specific queries using the above trees, any side-lane attributes that are required are retrieved direct from an in-memory representation of the document containing the static layer 414. A predicate is applied to the entire tree and only those indexed values that satisfy the predicate are considered. A range of predicates may be supported (e.g. lane-type, supporting road-type (in-junction or not), etc.) and arbitrary combinations may also supported, e.g. ‘get me the nearest side-lane that is a driving or a biking lane that is in a junction’.

Road/lane attributes are not stored within the spatial indices in the described examples (but could be in other implementations). Rather, the index is first filtered based on the active predicate(s) and the query is run on the filtered index (such that element that do not satisfy the active predicate(s) are not considered in processing the query).

As will be appreciated, the specific choices of index and query types summarized above are not intended to be exhaustive, but are merely illustrative of how the techniques may be applied in a particular implementation.

### Example Road Network:

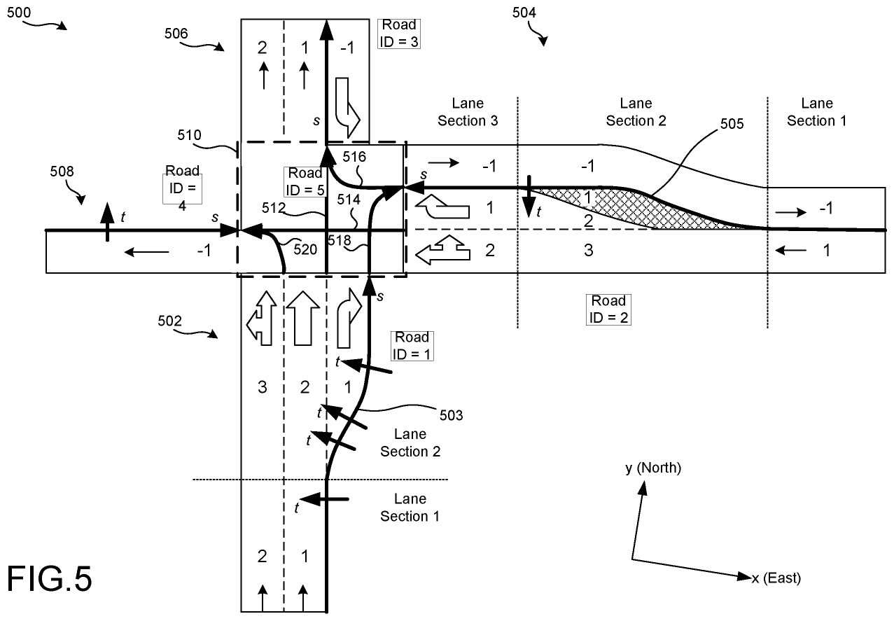

FIG. 5 schematically depicts an example road network 500 of the kind encoded in the static layer 414. The following description assumes the road network 500 is described using the OpenDRIVE schema, or a similar format that adopts certain definitions and conventions from OpenDRIVE. However, it will be appreciated that the principles extend more generally to other formats, and the described techniques are not limited to any particular data format or schema.

The road network 500 is shown to comprise first, second, third and fourth roads 502, 504, 506, 508 (Roads 1 to 4), which are described with <road> elements having road identifiers (IDs) 1, 2, 3 and 4 respectively. The roads 502-508 are interconnected via a junction 510 described by a <junction> element. Each of the roads 502-508 is defined by a single road reference line, denoted as a thick solid arrow, and contains a single center lane of width zero. The center lanes are not depicted separately, and for simplicity it is assumed that the center lane of each road 502-508 lies along the road reference line (although, as noted, it is possible to define a non-zero offset between the road reference line and the center lane). The road reference lines of the first and second roads 502, 504 are denoted by reference numerals 503 and 505 respectively. A road reference line is directional, and could be described more precisely as a longitudinal axis or “s-axis” of the road, with s-coordinates running along that axis, and t-coordinates running orthogonal to it. As depicted for the reference lines 503, 505, the positive t-direction is defined as extending to the left of the s-axis.

A left-hand traffic (LHT) road system is depicted in this example. However, the schema can be used for either LHT or right-hand traffic (RHT) networks. A “rule” attribute of each <road> element indicates whether the road is LHT (vehicles drive on the left) or RHT (vehicles drive on the right).

A global cartesian coordinate system is defined with the x-direction lying eastwards and the y-axis extending northwards (OpenDRIVE calls this the inertial coordinate system).

Lane numbers only indicate relative directions of traffic flow within a road: for any given road, traffic flows in the same direction for positively-numbered one-way side-lanes, and in the opposite direction for negatively-numbered one-way side-lanes. Bi-directional lanes support traffic flow in both directions irrespective of the road traffic rule. However, the lane number alone is not sufficient to infer the direction of traffic flow, as the direction of the s-axis can be (more or less) arbitrarily chosen and does not indicate driving direction. For example, in FIG. 5, the s-axis 505 of the second road 504 extends towards the junction from the east, whilst the s-axis of the fourth road 508 extends in the opposite direction towards the junction 510 from the west. Along the second road 504, positive lane numbers therefore denote a direction of traffic flow from east to west, whereas along the fourth road 508, east-to-west traffic flow is denoted by negative lane numbers. For a LHT road, lanes to the left of the road reference line (+t) carry traffic in the direction of the road reference line (+s), whereas lanes to the right of the road reference line (−t) carry traffic in the opposite direction (−s). In an RHT road, lanes to the left of the road center line (+t) carry traffic in the opposite direction of the road reference line (−s) and lanes to the right (−t) carry traffic in the direction of the road reference line (+s).

It is also possible to define a bidirectional side-lane, permitting traffic flow in both directions, by setting a @type attribute of the <lane> element to “bidirectional”. Bidirectional lanes are addressed in more detail below.

Therefore, in order to determine the absolute direction of traffic flow, the lane number is not sufficient; the direction of the road reference line (s-axis) must also be considered, as must the @type attribute.

Lanes are not necessarily drivable. For example, Lane 1 of Lane Section 2 of Road 2 is non-drivable. The outer boundaries of a road may also be defined by non-drivable lanes (such as lanes of a pavement/sidewalk type).

Link elements are used to explicitly define linkage between roads and lanes. With only two roads, links can be defined with link elements between roads directly, provided the links are unambiguous. More complex linkage requires the use of junction elements.

A <link> element can have one or both of a <successor> element and a <predecessor> element. The predecessor/successor of a road can be another road or a junction. The predecessor/successor of a lane is another lane. “Predecessor” and “successor” relationships are defined relative to the s-axis of the road in question (a road's t-axis runs from its predecessor, if any, to its successor, if any), and do not denote driving direction. The s-axis of a road runs away from its predecessor (if any), towards its successor (if any).

Predecessor/successor relationships may be ‘asymmetrical’. For example, if Road n is a predecessor of Road m, that does not imply Road m is a successor of Road n; if the s-axis of Road n runs in the opposite direction to the s-axis of Road m, then Road m could also be a predecessor of Road n. As another example, if Road m is part of a junction, then Road m cannot be a predecessor or successor of Road n, because the junction would be the predecessor/successor of Road n instead (see below for further examples).

Within the junction element 510 of Figure, additional roads are defined, whose reference lines are depicted as thick, solid arrows. Fifth to ninth roads 512, 514, 516, 518, 520 (Roads 5 to 9) are depicted within the junction 510 in this example. Although side-lanes within the junctions 510 are not depicted in FIG. 5, each road within the junction 510 is also required to have at least one side-lane of non-zero width.

In FIG. 5, the junction 510 is a successor of the first, second and fourth roads 502, 504, 508 because their respective s-axes extend towards the junction 510. Therefore, the <road> elements describing those roads 502, 504, 508 would contain <link> elements with <successor> elements indicating the junction 510. The junction 510 is a predecessor of the third road 506 because its s-axis extends away from the junction, and the <road> element describing the third road 506 would therefore contain a <link> element with a <predecessor> element indicating the junction 510.

Within the junction element 510, connecting roads are described by <road> and <connection> elements.

The fifth road 512 (Road 5) is shown to connect the first and third roads 502, 506. The fifth road 512 is defined by a <road> element within the <junction> element 510, of which the first road 502 is a predecessor and the third road 506 is a successor (defined via <predecessor> and <successor> elements in the <road> element describing the fifth road 506). Similarly the sixth road 514 has the fourth road 508 as its successor and the second road 504 as its predecessor. The seventh road 516 connects the second and third roads 504, 506, with the second road 504 as its predecessor and the third road 506 as its successor. The eighth road 518 connects the second and first roads 504, 502, with the second road 504 as successor and the first road 502 as predecessor. Finally, the ninth road 520 connects the first and fourth roads 502, 508, with the fourth road 508 as its successor and the first road 502 as its predecessor. Again, the predecessor/successor relationships are not direct indicators of driving direction.

A <connection> element is used to indicate driving direction for traffic joining a junction. A connection element indicates an incoming road and a connecting road (but does not explicitly define an outgoing road), with traffic entering the junction from the incoming road onto the connecting road. For example, a first <connection> element would be provided that indicates the road with ID=1 (the first road 502) as an incoming road and the road with ID=5 (the fifth road 512) as a connecting road; this connection element indicates that traffic can enter the junction 510 from the first road 502 onto the fifth road 512. A second <connection> element would indicate the first road 502 as an incoming road and the eighth road 518 as a connecting road, etc. The seventh connecting road 516 is a two-way road in this example, carrying traffic from the second road 504 to the third road 506, and traffic in the opposite direction. Therefore, two <connection> elements would be used, one indicating the second road as incoming and the seventh road 516 as connecting, and the other indicating the third road 506 as incoming and the seventh road 516 as connecting. The OpenDRIVE specification strongly advises one not to use two-way connecting roads, although two-way connecting roads are possible using the schema. The seventh connecting road 516 goes against this advice, but does not violate it (and, in practice, it is more likely that two one-way connecting roads would be defined). The fourth road 508 is not an incoming road to the junction 510 (even though its s-axis extends towards the junction 510), because it is a one-way road that only carries traffic away from the junction 510.

A connecting road with multiple lanes is used when lane changes are possible within the junction 510; if lane changes are not permitted, multiple single-lane roads would be used instead.

A “virtual” connection can also be described using a <connection> element without any connecting road. Virtual connections are limited to “virtual” junctions, which do not require a main road to be split up.

There are many contexts in which it would be useful to determine a route through all or part of the road network 500 in terms of lanes. This is referred to herein as “microplanning”. The aim of micro planning is to determine one or more directed lane sequences (“micro routes”) that satisfy some given criteria (such as a current and target lane). Whilst it is often drivable side-lane sequences that are of interest, non-drivable sequences may be considered e.g. to route pedestrians.

FIG. 6 shows part of the road network 500 of FIG. 5, annotated with sections of OpenSCENARIO code that define certain elements of the road network.

Starting from any lane of any of the incoming roads 502, 506, 506, the <connection> elements within the junction describe all possible routes though the junction 510 (at the road level). For a given lane on a given road, obtaining a list of all routes through the junction would mean locating all of the <connection> elements that identify the road in question as an incoming road, via its road ID, and which also have a lane linked to the lane in question.

A first code portion 602 contains a connection element (connection ID=0) that indicates the first road 502 (the road with ID 1) as an incoming road and the fifth road 512 (the road with ID 5) as a connecting road. First and second <laneLink> elements link Lane 3 of Road 1 (its incoming road) to Lane 2 of Road 5, and Lane 2 of Road 1 to Lane 1 of Road 5. A second portion of code 604 contains the <road> element describing Road 5 within the junction 510 (junction ID=0). A <link> element within the road element contains both <successor> and <predecessor> elements. The road link in the predecessor element indicated Road 1 as the predecessor to Road 5, which mirrors the lane links in the corresponding <connection> element (Connection 0). The successor element indicates the third road 506 (the road with ID 3) as successor to Road 5. A <lane> element is also shown within the road element for Road 5, which describes Lane 2 of Road 5 (other lane elements are omitted for conciseness); the lane element contains a link element, which in turn indicates Lane 2 as its successor and Lane 3 as its predecessor. To meaningfully interpret the lane links, it is necessary to consider the road link information; Road 1 is the predecessor to Road 5, therefore Lane 3 of Road 1 is the predecessor of Lane 2 of Road 5; Road 3 is the successor to Road 5, therefore Lane 2 of Road 3 is the successor to Lane 2 of Road 5. A third code portion 606 contains the road element describing Road 3. The junction 510 (junction ID=0) is indicated as the predecessor to Road 3, and a lane element is shown that describes Lane 2 of Road 3 (other lane elements are omitted for conciseness).

As can be seen from the above example, extracting a relatively basic piece of information—in this case, the direct route though the junction from Lane 3 or Lane Section 2 of Road 1 to Lane 2 of Road 3—is fairly inefficient.

Moreover, for microplanning, it is not sufficient to simply consider lane links, as this would ignore other micro routes that involve lane changes. It is therefore necessary to consider lane changes separately. Lane numbering is useful here, because it allows adjacent lanes in the same driving direction to be identified. However, lane numbering is not necessarily determinative. For example, returning briefly to FIG. 5, it is not possible to move from Lane 2 of Road 2 to Lane 1 of Road 2 because the latter is non-drivable. Although not depicted in FIG. 5, additional lanes may be used to describe the boundaries of the road, such as border or shoulder lanes, or lanes which are only usable by certain forms of agent (such as bus or cycle lanes).

Moreover, OpenDRIVE accommodates bidirectional lanes, and it is, in principle, possible to change from a positively-numbered lane to a negative numbered lane, or vice versa, if the destination lane is bidirectional. That said, in this particular implementation, the topological index 411 (‘DirectedSideLaneGraph’) as exposed through the SQE API 403 does not support lane change transitions that cross the road center-line (even if the target lane were bi-directional). In any case, the topological index 411 guarantees that any available transition will be supported by consistent driving directions (a route will never be returned down a one-way street in the wrong direction).

### Lane Graph

FIG. 7 shows part of a directed side-lane graph 700 generated for the road network 500. The directed side-lane graph 700 is referred to simply as the lane graph 700 for conciseness. The lane graph 700 describes lane interconnections from Road 1 though the junction 510. As described above, the lane graph 700 is an in-memory data structure that serves as an index for topological queries.

The lane graph 700 is implemented in memory as a collection of vertex descriptors to refer to the vertices of the graph (the directed side-lane references) and a collection of edge descriptors to refer to links (directed edges) between them; each vertex descriptor is then associated with a collection of incoming edge descriptors and a collection of outgoing edge descriptors. These descriptors are separate from the publicly exposed descriptors shown in FIG. 4, but the vertex descriptors do correspond to the directed side-lane descriptors (that association is managed internally).

For example, first and second nodes 702, 704 correspond, respectively, to Lane 1 of Lane Section 1 of Road 1 and Lane 2 of Lane Section 2 of Road 1. An onward edge 706 indicates the topological relationship between those lanes, namely that the latter is an “onward” lane from the former (i.e. a vehicle can traverse from the former to the latter without performing a lane change maneuver). An edge descriptor is associated with the nodes 702, 704 that defines the directed edge from the former to the latter with an indication of edge type (“onward” in this case). A node or edge descriptor can be contained in a single memory address or multiple memory addresses (e.g. in a block of memory addresses).

The lane graph 700 is constructed by interpreting the code of the static layer 414. Note that edges of the lane graph denote driving direction. To determine onward edges, lane links need to be considered, but driving direction also needs to be considered.

Edges are also provided for left-right relationships. For example, third and fourth nodes 708, 710 are depicted, representing Lanes 3 and 1, respectively, of Lane Section 2 of Road 1. A right edge 711 from the second node 704 to the fourth node 710 represents the possibility of moving from Lane 2 to Lane 1 of that lane section via a right lane change maneuver. A left edge 709 from the second node 704 to the third node 708 represents the possibility of moving from Lane 2 to Lane 3 via a left lane change maneuver. The left and right edges 709, 711 are stored in memory as edge descriptors, with an indication of their respective types (“left” and “right”). This information is not provided in <link> elements of the underlying description, but is obtained from the structure of the road as explained above.

A fifth node 714 represents Lane 1 in the only road section of Road 5, which is an onward lane from Lane 2 in Lane Section 2 or Road 1. Therefore, an onward edge 712 is directed from the second node 704 representing the former to the fifth node 714 representing the latter.

As will be appreciated, there are various ways a graph structure of this nature can be encoded in memory, such that topological relationships within the road network 500 are encoded as in-memory pointers between nodes that represent road structure elements. Whilst FIG. 7 depicts a lane graph, a similar geometric index can be constructed at the road level, with nodes representing roads, and pointers representing topological relationships between the roads.

In the lane graph 700, a second lane is said to be connected to a first lane if there exists an edge from the first lane to the second lane (implying that it is possible to move from the first lane into the second lane). As indicated, this concept of “connections” in the lane graph is distinct from the concepts of links in OpenDRIVE.

Considering the microplanning query above, topological queries can be accommodated highly efficiently. For example, given a current lane and a goal lane, micro routes from the former to the latter can be easily determined as a set of paths through the lane graph 700 from the node representing the former to the node representing the latter.

Lane sections do not have explicit identifiers in OpenDRIVE. However, they are implicitly indexed by the order in which they appear in the applicable <Road> element. These implicit indices are used to reference Lane Sections within the SQE 402. Specifically, the SQE 402 uses a zero-based index of the lane-section in the road.lanes( ).lane_sections( ) collection.

FIG. 8 shows further details of part of the lane graph 700. Each edge has an associated cost stored in association with it. For example, the cost may be contained in the edge descriptor describing that edge. For the sake of illustration, the figure shows costs 709C, 711C and 712C associated with the left, right and onward edges directed from the second node 704 to the third, fourth and fifth nodes 708, 710, 714 respectively. Costs for other edges in the graph are not shown, but each edge of the lane graph 700 is associated with a cost in this manner. The costs take the form of distance penalties that facilitate a fast search for the shortest micro-route from one node to another. In practice, this search will be approximate. For a given lane sequence, the actual distance travelled will, in practice, have some dependence on driver (or other actor) behaviour, such as the timing of lane change maneuvers, the extent of lateral movement within a lane etc. Nevertheless, it is possible to assign each edge of the graph 700 a cost that is generally representative of distance travelled.

When an onward edges in the directed side-lane graph 700 is traversed, a cost is incurred that is equal to the physical length of the source side-lane mid-line (measured from the beginning of the supporting lane-section). That is, for an onward edge from one lane to another, it is the length (longitudinal extent) of the former that is material. Thus, the distance penalty 712C associated with the onward edge from the second node 704 to the fifth node 714 depends on the length of Lane 2 in Lane Section 2 of Road 1. Conceptually, route planning from a given node (at the start of a route or along a route) begins at the start of the lane, as defined by driving direction. To reach an onward lane from the start of a current lane requires the given lane to be driven (or otherwise traversed) in order to reach the onward lane. Hence, to support this form of route planning, the cost of an onward edge from a current lane to an onward lane is given by the length of the current lane (not the onward lane), or any suitable function of the length of the current lane.

When a neighbouring edge in the lane graph 700 is traversed, a cost is incurred that is equal to the distance between the supporting side-lane mid-lines. That is, for a left or right edge, lateral distance is material. For example, the cost of a left or right edge from a current lane to a neighbouring (left or right) lane may be a lateral distance between the current lane and the neighbouring lane. The lateral distance need only be approximate and generally representative of the additional travel distance incurred by a lane change. Indeed, one aim is to prevent a cost-based search of the graph from returning routes with excessive left-right lane changes (e.g. switch back and forth between the same two lanes repeatedly), and to achieve this, any non-zero cost of sufficient magnitude may be used (because each ‘unnecessary’ left/right lane change adds to the overall cost).

The point at which the lateral distance is measured is arbitrary, and one option is to use the maximum of the inter side-lane mid-line distance at the start and the end of the supporting lane-section (to keep it symmetric). In this case, the distance penalty for a left/right edge is taken as the lateral separation between the current lane and the neighbouring lane (or some function thereof) at the start of the current lane or the end of the current lane (whichever is greater). Ideally one might want to use something more representative of any excess arclength introduced by making the lane-change, but the simpler heuristic it is sufficient for the current purposes. In any event, as noted, any lateral distance penalty sufficient to prevent repeated or unnecessary left/right lane changes may be sufficient.

It will be appreciated that distance-based costs can be constructed in other ways, and that the exact choice will be implementation-specific. In the context of a route planning query, distance-based costs need only be generally representative of travel distances associated with lane changes (in the broad sense), with the aim of finding an approximate shortest route (in the geometric sense) between any two given nodes of the graph 700. Other forms of cost may also be defined to support other types of topological query. In this context, although the query and the lane graph 700 are topological in nature, the costs are based on lane geometry. Geometric costs allow geometric information to feed into topological queries without compromising runtime performance.

As noted, one example of a topological query at the SQE API 403 is a route-planning query that provides descriptors 423 of a desired start lane and a desired end lane. In order to respond to this query, a depth-first search is performed, taking into account the edge costs, with the aim of finding the lowest-cost route (lane sequence) from the start lane to the end lane. This will not necessarily be the route with the fewest lane changes; although the query is topological in nature, the costs are based on lane geometry. Although the costs generally discourage lane changes, it is the overall cost that matters. For example, in a road with high curvature, a lane closer to the center of curvature may be materially shorter (longitudinally) than a lane further from it (one concrete example being a roundabout; the innermost lane of a roundabout may be significantly shorter that the outermost lane). In this case, the additional penalty incurred by one or more left or right lane changes may be less the “saving” gained by choosing a shorter lane closer to the center of curvature.

Another application is roundabout detection, which is described in more detail later herein. Roundabouts may be identified by identifying one-way loops in graphs of roads, from the lane graph representation 700. An additional query mode to find any one way loops can be provided for this purpose. A slight ‘coarsening’ of the directed lane graph may be used to detect roundabouts in which only the road links are retained. A coarser road topology index may be constructed, for example, with nodes representing <road> elements (retaining information about their constituent side-lanes, but not the individual lane links) and edges representing links between roads. Each node also contains a distance cost (the length or approximate length of the corresponding road element in units of distance) to enable distance-based queries on the graph, such as a distance-limited query. The system looks specifically for loops in the directed road graph that begin in the connecting road of junctions and are solely composed of one-sided roads ( ) roads with only left or right lanes. All of the lanes in the connected loop that forms the roundabout itself will support traffic flow in the same compatible direction.

In a simulation context, the SQE 402 can support a scenario simulator, and in a run-time context it can support planning/predictions functions within the stack 100.

An alternative to the SQE 402 described above approach would be to run such queries on the static layer 412 (OpenDRIVE document) directly, via a lightweight view of the original document. However, the current OpenDRIVE format (v1.6.1) is too implicit a description of the road network to do this efficiently.

Instead, the geometric and topological indexes 409, 411 provide geometric and topological “views” of the document 414 (in the formal database sense).

The indexes 409, 411 are immutable, in that they are derived once from the static layer 414 and not varied.

### Map Annotation Tooling

As described previously, <junction> elements are configurable within the OpenDRIVE schema. Junction elements are required when linking more than two road elements together. The OpenDRIVE schema further enables a data structure representing a group of one or more junction to be defined; such a group of junctions may, for example, be classed as a roundabout or some other predetermined road structure type. OpenDrive defines a <junction group> element used to group one or more junctions, with a header element and a series of member elements. The <junction group> element may be configured with a “name”, a unique “ID”, and a junction group “type”, where a value in the “type” field may, in some examples, indicate that the junction group represents a roundabout. A map may be annotated, for example, by adding a <junction group> element (or other syntax element) and/or by setting an attribute of a new or existing element (such as the type field of a junction group).

Roundabouts may be described using the OpenDRIVE schema, but typically roundabouts would have to be annotated manually by a designer or user of a map. OpenDRIVE does not define the concept of a roundabout physical attributes of roundabouts, and is therefore down to a map annotator to judge whether or not a set of junctions qualifies as a roundabout. This can lead to inconsistent annotations, particularly for more ambiguous edge cases.

Whilst the description that follows primarily focuses on identification of roundabouts in a road graph, it will be appreciated that the same techniques may be applied to identify other types of road structure that may be characterized in terms of subgraphs.

A roundabout is defined herein as a continuous, closed and one-way loop of linked <road> elements. A one-way road element contains driveable side-lane(s) on either only the left side or only the right side, and a one-way loop is formed by linked one-way road elements (In this context, the material thing is the driving direction of the lanes. Valid situations frequently arise where not all of the lanes in a loop are on the same side of their reference line, but the driving direction is the same for all lanes). To identify a continuous loop of road elements, only road <links> need to be considered. To determine whether a <road> is one-way, the direction of its constituent side-lane(s) needs to be considered, but lane links do not need to be considered. Hence a coarser and more ‘lightweight’ road topology graph can be used with edges encoding road links rather than lane links.

Sub-graphs with similar topologies may have quite different geometries, and in particular can encompass a wide range of road sizes. In one implementation, a distance limit or other size limit is placed on the sub-graph search, to limit the length of road (in metres) that is considered. For example, when searching for loops, a distance limit may be placed on the size of the loop that is considered. The distance limit is incrementally increased, searching initially for the smallest sub-graphs (measured in distance), and gradually increasing the limit on the side of the sub-graph. When a smaller sub-graph is found, that part of the graph is excluded from subsequent searches, which in turn limits the scope of subsequent searches on larger sub-graphs. In addition, when a road element is found that cannot form part of a sub-graph of interest, it is also excluded from subsequent searching. For example, in roundabout detection, a search for loops may be performed initially over the entire graph but using a relatively small distance threshold, to reduce search costs. Any loops that are found in the initial search are excluded from subsequent searches. Moreover, any two-way roads located in the initial search can also be excluded at that point, as such roads cannot form part of a roundabout, or roads which have already been annotated (e.g. manually annotated beforehand in a partially annotated map) The computational cost of searching increases with the size of sub-graph considered, therefore limiting the scope of the search for larger sub-graphs yields a significant performance benefit.

### Roundabout Detection

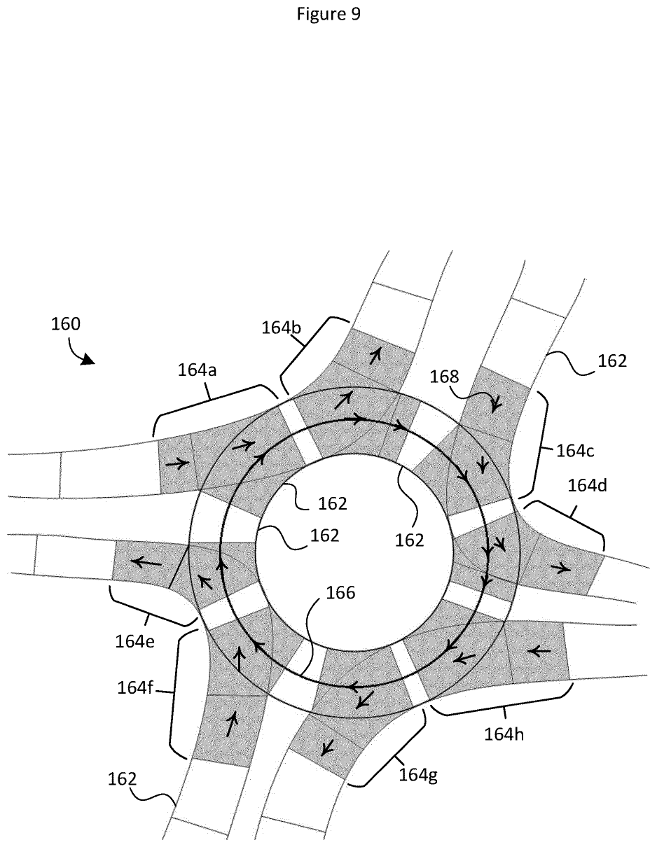

Reference is made to FIG. 9, which shows an exemplary static layer 160 comprising network of road elements 162, of which a subset forms a “roundabout”, as would be understood by a human road user, and as should be understood by an autonomous vehicle or a testing platform configured to identify roundabouts. FIG. 9 shows an exemplary static layer which comprises a road structure that should be identified as a roundabout by the presently described tool.

According to the OpenDRIVE schema, a roundabout necessarily comprises a group of one or more junctions, and junction elements themselves encode sections of road where three or more road elements need to be linked. FIG. 9 shows a group of 8 junctions 164a-164h, which represent entry and exit points to an associated roundabout. Therefore, the plurality of junctions 164a-164h may optionally be grouped by a <junction group> element (but the schema does not mandate the use of junction groups).

In addition to comprising a plurality of junctions, the static layer of FIG. 9 exhibits further structural features which indicate that a roundabout is present. Firstly, the plurality of junctions 164 are interconnected by a sequence of road elements 162 that form a unidirectional closed loop, as indicated by ring 166. It will be appreciated that some of the road elements 162 forming the closed loop 166 may also form part of one or more junction 164 in the static layer, because the road elements traversing the loop may be linked (in the indexes) to road elements defining entry and/or exit points on the roundabout so that, in practice, vehicles may merge onto the loop, or peel off at a junction.

It will also be noted that the level of map detail shown in FIG. 9 is limited to road elements, Lane links within and between each road elements are not shown. Direction indicators 168 are shown on certain road structure elements 162 within the static layer 160. For clarity, only the road elements 162 that form part of a junction 164 are shown with a direction indicator 168, though it will be appreciated that non-labelled road elements are also associated with a direction that is consistent with other elements to which they are linked.

Whilst the closed loop 166 of FIG. 9 is substantially circular, the extent to which the loop 166 is circular may have no effect on the output of the method for identifying an instance of a roundabout. However, other factors such as a distance around the loop may be assessed when identifying whether a roundabout is present in a static layer. For example, in a static layer, there may exist large unidirectional loops of road elements which enable travel between a plurality of junctions which would not be considered roundabouts by a human driver. Similarly, in embodiments where autonomous vehicles adjust their planning behaviour at a roundabout, it may be undesirable to identify closed looped road structures above a threshold distance as constituting roundabouts for the purposes of, for example, planning behaviour at an entry/exit junction.

### Roundabout Detection Method

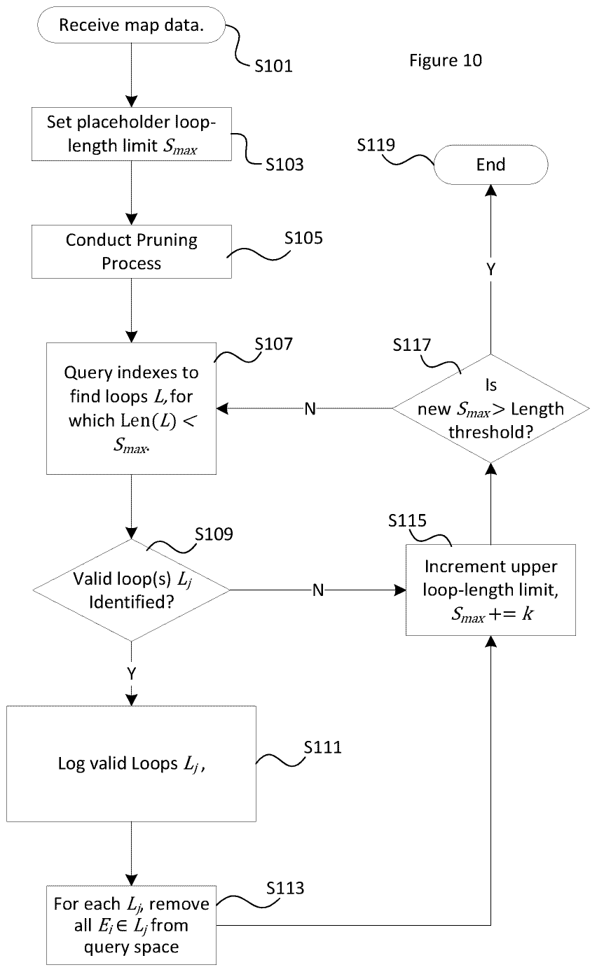

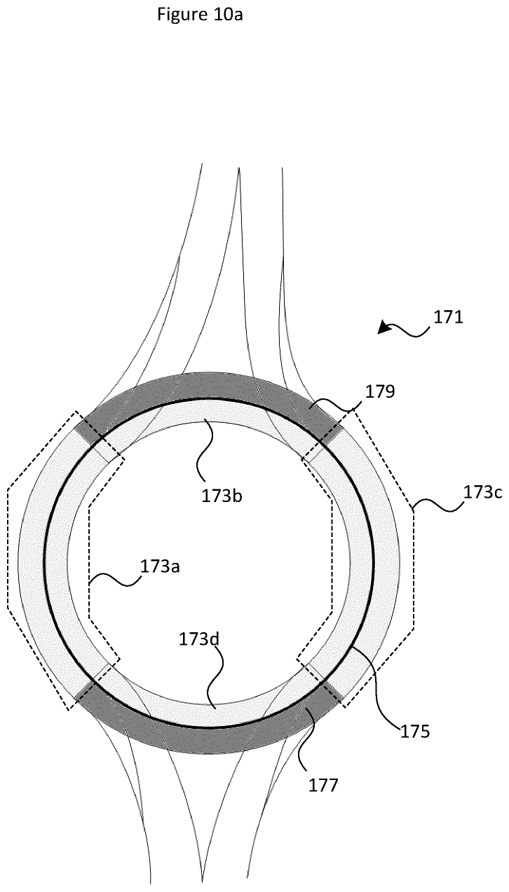

Reference is now made to FIG. 10, which shows a flowchart that represents an exemplary computer-implemented method for identifying roundabouts within a static layer. Roundabouts are detected based on identifying one-way loops in the target graph, but the methodology can be applied to other forms of subgraph.

The aim is to find one-way loops that traverse at least one junction, which itself does not already belong to a junction group of type ‘roundabout’ (in order to gain the ‘roundabout’ annotation, by creating a junction group that includes that junction).

All loops found by the process are guaranteed to include at least one junction since, as an important performance consideration, at each stage the method is searching for loops from roads that are within junctions (and not already in roundabout junction groups).

The precise steps of FIG. 10 are not intended to limit the scope of the invention, but merely provide a detailed example of how a query may be conducted. Alternative steps may be taken in some embodiments and, outside the constraints of a particular embodiment, steps S103-S119 of FIG. 10 may be condensed into a single block, labelled: ‘execute query based on input road graph’.

The exemplary flow of FIG. 10 begins at a step S101, wherein map data is received. The map data may be a road graph intended to represent a search space for a query; the map data may therefore constitute a target road graph, as defined previously herein. As also described previously herein, with reference to FIG. 4, a system component 401 requiring access to data held in the geometric index 409 and/or topological index 411 may communicate with a scenario query engine (SQE) 402 via an API 403. The step of receiving map data at S101 may comprise establishing communication between a system component 401, which may be a roundabout detection module, and the SQE for the purpose of querying road links between road elements. Alternatively, the target road graph may be a subset of a larger, more detailed, OpenDrive document that describes the whole static layer, including lane structures. The smaller road graph may be held in a read-write memory, accessible to a processor that conducts the query.

The remaining steps shown in FIG. 10 are specific to a particular embodiment, and do not limit the scope of the invention; alternative steps may be taken to implement a query. For example, in another implementation, a query may be conducted by identifying instances of graph isomorphism between a target road graph and an input graph, where the input graph may define a roundabout or any other structure that may be characterised by road structure and topology, independent of internal lane structures.

At a step S103, a placeholder loop-length limit Sₘₐₓ may be defined. The loop-length limit Sₘₐₓ may be defined in units of distance, such as metres. Distance costs in the nodes of the graph can be used to efficiently compute a total distance along a sequence of roads. The total length of a road sequence is determined by summing the distance costs of the corresponding nodes. A distinction between the placeholder loop-length limit Sₘₐₓ and the loop-length threshold described above should be recognised. The loop-length threshold described with reference to FIG. 9 defines an upper boundary of loop length, above which a loop in road elements of a static layer should not be considered a roundabout. By contrast, the placeholder length limit Sₘₐₓ defines an initial query space for loops in a static layer; i.e., query for loops in road elements up to a length of Sₘₐₓ. For reasons that will become clear in the description that follows, the method may be repeated by iterating over incremental values of Sₘₐₓ between the first placeholder value (set at step S103) and the loop-length threshold (meaning the search starts with relatively small loops, gradually working up to the maximum loop size). Both the placeholder value Sₘₐₓ and the threshold value may be stored in a memory component of the roundabout detection tool.

At a next step S105, a pruning process may be conducted. The pruning process of step S105 may include iterating over the road structure elements in the target graph, identifying those structures which i) are already included in a junction structure and a junction group structure or ii) are not one-way structures, and removing those structures (and their links) from the query space. That is, road structures which do not need to form part of the space in which loops are searched for may be disregarded before a loop query is performed. The pruning process of step S105 may be implemented based on considerations of reducing demand for computing resources. That is, the subsequent search for loops is a computationally intensive process, and the step of removing road structures which cannot exist in new roundabout structures (e.g. multi-directional roads, and road structures that are already in both a junction and a junction group) reduces computational demand of the query, and improves speed and efficiency of the tool that implements the query. It will be appreciated that other pruning conditions than those identified above may be implemented, such that other types of road structures may be disregarded in a subsequent search for loops.

After pruning road structures which need not be in the query space at step S105, the flow continues to a step S107, wherein the roundabout detection tool may instruct the SQE to identify one or more road element set (Lⱼ), wherein each set Lⱼ comprises a plurality of road elements (Eᵢ) through which a closed-loop path of distance Sⱼ<Sₘₐₓ may be generated, and wherein, for each road element set Lⱼ:

$${S}_{j} = {\sum }_{i = 1}^{i} len ( {E}_{i} ) , for {E}_{i} ∈ {L}_{j}$$

Note that since the loop length Sⱼ of a road element set Lⱼ is equal to the sum of the lengths of each constituent road element Eᵢ∈Lⱼ, it holds that the loop path must pass through a road element for that element to be included in a set L, and the loop path may only pass through a particular road element once (since its length only contributes to the calculation of Sⱼ once). As will be appreciated by those skilled in the art, other ways of calculating the length of a looped path Sⱼ may be employed in other embodiments. Additional query conditions may also be implemented. For example, the query may be configured to only consider loops that stem from road structure elements which are already known to form a junction excluding junctions that already belong to roundabout junction groups). Upon later identifying a loop structure as a result of the query, it is therefore known that the loop is associated with at least one junction, which may be a characterising feature of roundabout structures.

The flow then progresses to a next step S109, wherein a determination is made as to whether one or more valid set of road elements Lⱼ—valid in the sense that it comprises road elements Eᵢ that form a loop path for which Sⱼ<Sₘₐₓ—has been found in the associated (pruned) static layer/target graph.

If the determination at step S109 indicates that at least one valid loop Lⱼ, which satisfies the loop-length constraint Sₘₐₓ, exists in the road topology graph, the flow continues to a next step S111.

In some embodiments, the identified loops Lⱼ may be given a loop index j such that larger values of j are associated with loops of a higher loop length. In such an embodiment, step S109 may further comprise a ranking step wherein the identified loops are ranked according to increasing loop length. This may assist in a loop disambiguation step which is described in more detail later.

A next step, S111, includes storing, for each identified loop Lⱼ of road elements Eᵢ, an indication of a map location comprising the road elements Eᵢ and the identified junctions associated therewith. In some examples, step S111 may comprise defining, for each Lⱼ, a <junction group> data structure of the “roundabout” type. In some examples, step S111 may further include further steps of ensuring that all road elements in the target graph that contribute to forming each identified loop are included in the corresponding sets Lⱼ of road elements Eᵢ. This is because multi-lane roundabouts may be annotated in such a way that different lanes of the roundabout are represented by ‘roads’ in an OpenDRIVE file, thereby enabling a loop of road elements to be identified, without identifying all road elements that should be considered to form part of a roundabout (i.e., a part of an extra lane in a roundabout is missed when conducting the loop query). That is, once a cycle or loop is found, additional processing may take place to make sure all the lanes of the roundabout that the cycle represents are identified. The result is no longer just necessarily a cyclic path of roads but more generally an unordered set of roads that together form the roundabout ring. This may assist in a next stage of signal placement, discussed later herein.

An example of such a roundabout is shown in FIG. 10a, and is denoted by reference numeral 171. The roundabout 171 of FIG. 10 comprises a plurality of road structure elements through which closed loop path 175 can be identified. The roundabout 171 includes a first plurality of road structure elements 173a-173d, which may represent road elements identified in a loop query. The first plurality of road structure elements are shown with a first (light-grey) shading. The roundabout 171 further comprises two additional roads 177, 179, which form part of the roundabout, but which have not been identified in a loop query. Some tools are incapable of creating multi-lane connecting roads, so additional roads 177 and 179 may be defined as distinct road elements despite, in the wider context of the roundabout, forming separate lanes in the roundabout. This means that a loop may be identified which only comprises road elements 173a-173d, but roads 177 and 179 must also be identified for accurate signal placement at the roundabout entry, hence the additional processing step. It will be noted that since signals may be placed at connections between multiple roads, and since the additional roads (e.g., 177, 179) may arise due to the presence of multi-lane connecting roads, a system that is capable of identifying such additional roads may have improved accuracy compared to those that do not.

In other examples, annotation of the original static layer may be performed in a separate sequence of steps that does not form part of the workflow shown in FIG. 10.

It will be noted that the data structures created to represent roundabouts may be overwritten in the original static layer data. That is, for purposes of minimising required storage resources, a separate copy of the static layer data comprising the roundabout indications is not stored. Instead, the data structures indicating locations and other properties of identified roundabouts may be saved over the original static layer data.

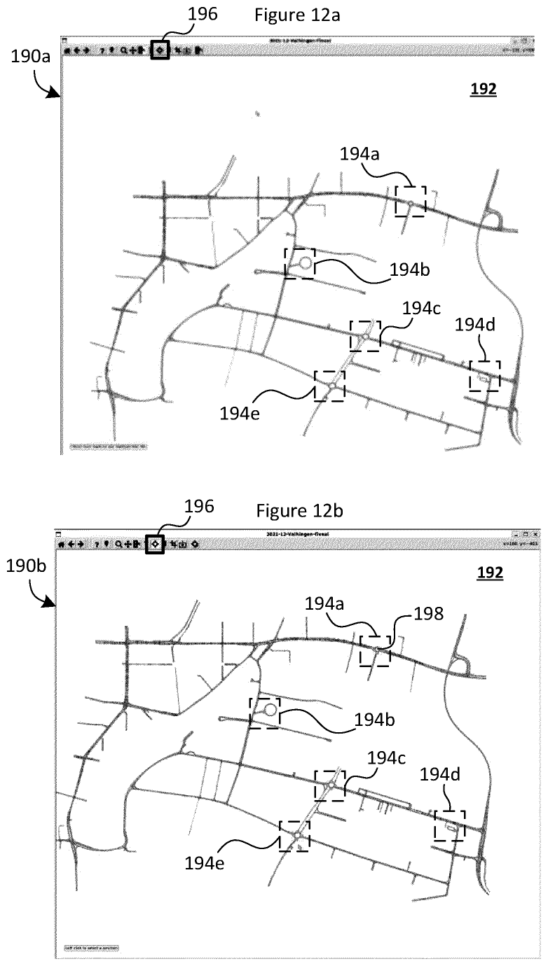

Step S111 may be performed such that a visual indication of identified roundabouts may be provided on a user interface configured to display a representation of the associated static layer. That is, a user interface configured to display a representation of the static layer may be configured, e.g., in response to a user input indicating a request for roundabout identification, to provide a visual indication of map locations at which a roundabout is considered to exist in accordance with the above method of identifying roundabouts. Such a user interface is described later herein with reference to FIGS. 12a and 12b.

Step S111 is followed by step S113 wherein, for each Lⱼ, all road elements Eᵢ∈Lⱼ are excluded from the query/search space. That is, road elements Eᵢ that are considered to form part of a roundabout, and have been recorded as being so at step S111, are excluded from the query space such that the same loops Lⱼ are not considered again at a next iteration of the method. Exclusion from the query space may be done by, for example, recording a road ID associated with each relevant element Eᵢ such that those road elements Eᵢ are not extracted or considered in a subsequent step in the overall query. As discussed above, there is a significant computational cost associated with performing a loop query. This cost scales with the length of the loops that are searched for. Therefore, road structure elements forming already-identified roundabout structures may be removed from the query space such that the query is not performed on the same loops multiple times. Step S113 may be considered to be a next iteration of the pruning step S105, in that the road elements that may be removed at S113 are those which are already included in a junction and junction group.

In other words, a subsequent search for longer loops doesn't ‘seek’ through any roundabouts that have already been found. In maps with even a small number of roundabouts, this reduces the search space a significant amount, which in turn has a significant performance benefit.

Searching for long loops is very expensive so it is desirable to rule out (prune) as many branches of the search as we can. At each iteration, when searching for loops, a road can be immediately pruned from the current search (and from subsequent search stages) if it is determined to be not one-way, or it is found to belong to a junction that already belongs to a junction group.

This iterative approach (rather than searching for all loops initially) dramatically prunes the ‘search space’ (assuming there are some roundabouts in the map)

The exemplary flow of FIG. 10 then progresses to step S115, wherein the loop-length limit Sₘₐₓ is increased in size by an arbitrary value k.

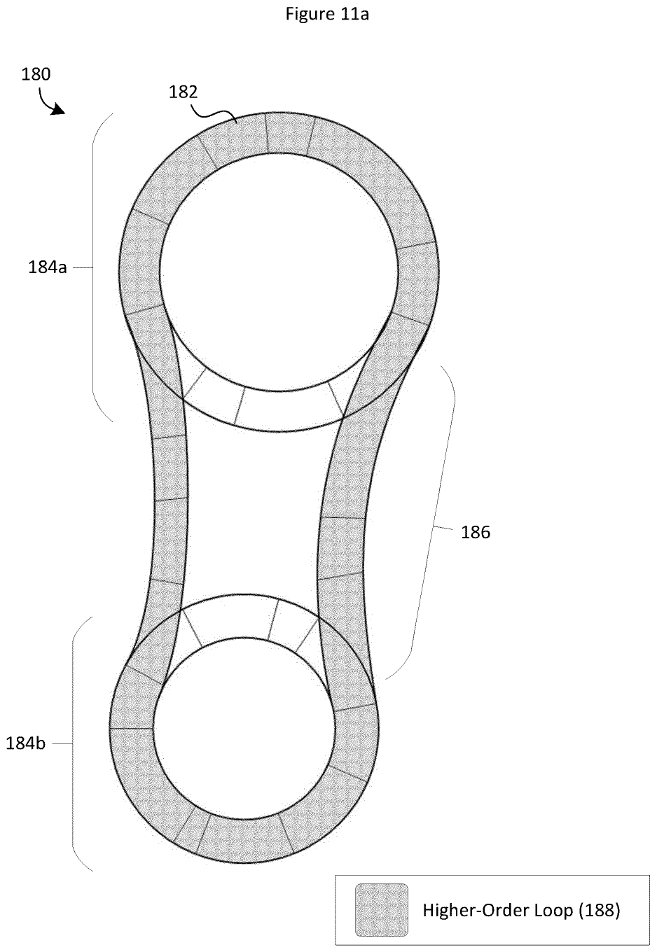

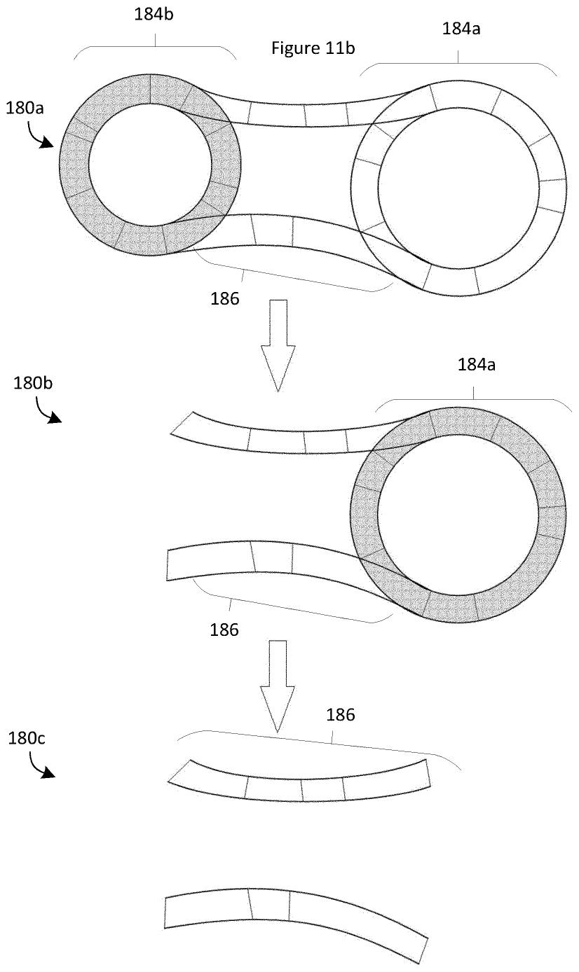

As Sₘₐₓ is increased by k, the loop query space increases, such that loops of greater distance may be identified. It is important to identify small loops before larger loops, because small roundabouts are sometimes linked to one or more other small roundabouts by segments of road that also form a loop. An example of such a situation, and the problems associated therewith, are described with reference to FIGS. 11a and 11b.

Note that the value of k may be selected to optimise the method by minimising required computing resources and maximising disambiguation efficacy between loops of different length in the road graph. That is, as k tends to 0, the number of times the method must be repeated times before Sₘₐₓ is equal to the loop length threshold increases. However, the reason for incrementing Sₘₐₓ by k is so that smaller loops (which for example form part of a larger, higher-order loop), may be identified first. Minimising k improves the ability of the system to disambiguate the smaller loops from the larger, higher-order loops.

Note that step S115 may be reached from two directions in the flow. In a first situation, step S115 may be reached from S113. This occurs when at least one valid loop is found at step S109. In a second example, step S115 may be reached directly from S109. This occurs when no valid loop (set Lⱼ of elements Eᵢ) is identified under the present Sₘₐₓ constraints.

Step S115 is followed by step S117, in which a determination is made as to whether the newly incremented loop-length limit Sₘₐₓ (incremented at step S115) is greater than the length threshold. That is, a determination is made as to whether another iteration of the roundabout identification process of steps S105-S115 should be performed with a larger value of Sₘₐₓ, or whether the new value for Sₘₐₓ exceeds the threshold distance for what should be considered a roundabout, and thus no further iterations of the process should be conducted.

If step S117 returns FALSE or No, then the flow returns to step S105 and the roundabout detection process is repeated for the new value of Sₘₐₓ, increased at step S115. Alternatively, if step S117 returns TRUE or Yes and the new Sₘₐₓ value exceeds the distance threshold, the flow continues to a step S119, wherein the roundabout detection process is considered to have ended, such that all loops of road elements up to the distance threshold have been detected and all of those loops which are associated with one or more junctions have been identified as roundabouts.

As will be appreciated by those skilled in the art, other methods for disambiguating smaller loops from larger loops may be employed. For example, rather than iterating over gradually increasing values of Sₘₐₓ, all loops in the map may be found in one query before those loops are ranked according to loop length. The identified loops may then be processed for junction compliance and excluded from the search space in ascending order of loop length/distance.

The above method of disambiguation may alternatively be implemented in addition to the iterative increases in Sₘₐₓ. This may be useful in examples where two or more identified loops have very similar loop lengths, and even small increments of Sₘₐₓ do not separate or disambiguate the loops.

It will also be appreciated that the method may comprise additional steps that further filter the received map data in respect of other parameters. That is, one or more additional characteristics of a roundabout may be required, and the requirement of such a characteristic may be encoded into the roundabout detection method so that all identified roundabout instances comprise the additional characteristic.

### Small-Loops-First Considerations

Reference is now made to FIGS. 11a and 11b, which demonstrate an issue which occurs when no small loop disambiguation step is performed when detecting roundabouts, and explains why the inventors have implemented a method which identifies the smallest loops first.

FIG. 11a shows an exemplary network 180 of road elements 182. The road elements 182 are shown to form a first loop 184a and a second loop 184b, wherein the first loop 184a has a larger loop length than that of the second loop 184b. However, the road network 180 further comprises a plurality of road elements 182 which form a connecting road 186 between the two loops 184a, 184b. The connecting road forms, in conjunction with a subset of the road elements 182 in the first loop 184a and a subset of the road elements 182 in the second loop 184b, form a larger, higher-order loop 188. In FIG. 11a, the road elements which form part of the higher-order loops 188 are shown to be shaded grey.

Note that since the higher order loop includes road elements 182 that form junctions, and there are more than two junctions associated with the loop 188 (at points where the connecting road 186 joins one of the loops 184, since three or more road elements are linked at those points), the higher order loop 188 may itself be considered a roundabout, prima facie. However, human drivers may not classify such a road structure as a roundabout and may not behave, on entry or exit to loop 188, as they would do at a roundabout. However, loops 184a and 184b may better constitute a “roundabout” as a human driver would understand one. Therefore, it is important to determine whether smaller loops represent roundabouts before considering whether larger loops do.

It will be appreciated that the “small-loops-first” method operates on the principle that if any two loops in a road network share one or more road element, the smallest of the two loops should be considered a roundabout, and the larger of the two loops—a higher order loop which shares a subset of the road elements of the smaller loop—should not be considered a roundabout.

According to the exemplary method shown in FIG. 10, the road elements 182 that form part of the higher order loop 188 (shaded grey) may, on identification of loop 188, be excluded from the search space over which subsequent steps of the overall query are to be executed. It will be appreciated that without expressly configuring a roundabout detection tool that identifies the smallest loops first, loops such as higher-order loop 188 may be identified before the likes of loops 184a and 184b. In such an example, the road elements 182 in loop 188 may be excluded from the graph before loops 184a and 184b are identified. Since loops 184a and 184b share road elements with the higher order loop 188, loops 184a and 184b could not be identified if the shared road elements 182 were to be excluded from the search space.

According to the method described with reference to FIG. 10, smaller loops would be identified first. The implications of this improved method are demonstrated in FIG. 11b. FIG. 11b shows three instances of the same road network 180 as in FIG. 11a. Note that for clarity, the road structure has been rotated 90° clockwise in FIG. 11b.

In a first instance of the road network 180a, the smallest loop 184b has been identified first, according to the method shown in FIG. 10. To indicate identification of loop 184b, the road elements 182 therein are shaded grey.

In the first road network instance 180a, where loop 184b is identified, a query for loops in an associated static layer may have been performed using a value of Sₘₐₓ that is greater than the loop length of loop 184b, but less than the loop length of loop 184a and the higher-order loop 188. Alternatively, a query may have been performed using a value of Sₘₐₓ that exceeds the loop length of both loops 184a and 184b (and may also exceed the length of higher order loop 188). In such an example, an alternative or additional step for disambiguating the loops, e.g., by ranking the loops by increasing length and processing the smallest first, may be implemented.

Upon identifying loop 184b and conducting other processing steps in the method, the road elements 182 within the second loop 184b are removed/excluded from the search space within the road structure graph. The second instance of the road network 180b shows an example where the road elements 182 in loop 184b are excluded.

Note that since the road elements 182 of loop 184b have been excluded from the search space, higher-order loop 188 can no longer be identified in the road network 180b.

The second instance of the road network 180b shows that loop 184a has been identified, as indicated by the grey shading. After the processing of loop 184b and the subsequent removal of its component road elements 182 from the search space, the remaining road elements 182 form the third road network instance 180c, which comprises only the connecting road 186.

Note that in some embodiments, road elements 182 which do not form part of a loop, but which form part of a junction that includes an element 182 which does form part of a loop, may also be removed from the data set on which further query steps are conducted. In such an embodiment, the four road elements at the left- and right-hand extremes of the connecting road 186 would also be excluded in network 180c.

### Exemplary User Interface

Reference is now made to FIGS. 12a and 12b. FIG. 12a illustrates a first instance 190a of an exemplary user interface 190. The user interface 190 shows a high-level overview of an exemplary static layer, comprising a plurality of roundabouts. The user interface 190 may be configured to receive user input for controlling the interface 190, and may enable a user to navigate, annotate, or perform other functions for analysing aspects of the static layer. FIG. 12a shows a map, or static layer 192 comprising a network of roads. The map may constitute a visual representation of a corresponding road graph. Dashed boxes 194a-194e are provided around instances of roundabouts within the map 192. However, the dashed boxes provided in FIG. 12a are for the benefit of the reader in identifying roundabout instances. It will be appreciated that in interface instance 160a, no automatic roundabout detection or annotation process has been conducted, and no indication of roundabout locations on the map 192 are displayed on the user interface 160 itself.

The user interface 190a of FIG. 12a is shown to comprise a selectable user interface element 196 corresponding to a roundabout detection tool. The selectable element 196 may be configured to, upon selection by a user of the user interface, conduct a roundabout detection and map annotation method according to any embodiment described herein. In the example of FIG. 12a, the selectable element 196 is in a first selection state, which indicates the tool is not activated. The selectable element 196 further comprises a visual indicator associated with the first selection state, the visual indicator provided such that the user may recognise that the corresponding roundabout detection tool is not activated.

FIG. 12b illustrates a second instance 190b of the same exemplary user interface 190 as is shown in FIG. 12a, and displaying the same map 192. In the example of FIG. 12b, the selectable element 196 is in a second selection state, which indicates the associated roundabout detection tool is activated. The selectable element 196 further comprises a second visual indicator associated with the second selection state, the second visual indicator provided such that the user may recognise that the corresponding roundabout detection tool is activated.

As a result of the selection of user interface element 196, each instance of a roundabout in the map 192 is identified on the user interface 190b with a roundabout marker 198. A roundabout marker may be constituted by a visual marker displayed on the map 192 at a location corresponding to a roundabout, and may comprise a particular colour, texture, icon or other visual sprite that a user of the user interface 190b would recognise as representing a roundabout location.

In some embodiments, a roundabout marker 198 may be constituted by a dot on the map 192, indicating a precise location at which a roundabout is located.

In other embodiments, a roundabout marker 198 may be constituted by a box, circle, or other 2-dimensional shape indicating a region of the map 192 that comprises a roundabout.

In some embodiments, a roundabout marker 198 for a particular roundabout may be constituted by (or further comprise) a plurality of dots, wherein a number of dots provided for a particular roundabout corresponds to a number of junctions within that roundabout, and wherein the location of the dots indicates a precise location of the junction within the roundabout on the map 192.

It should be noted that a roundabout marker 198 constituted by a box or 2D shape, as described above, may further include the presently described junction dots.

In practice, the effect of identifying roundabouts in the map 192 may be achieved by causing a query to be performed, upon selection of the interface element 196.

As discussed, the principles can be extended to other forms of road structure, identified within the lane graph. For example, a query may be run to identify instances of graph isomorphism between a target road graph and an input road graph. The road graph corresponding to the map 192 may constitute the target road graph, and the input graph may be constituted by a road graph that defines a generic roundabout topology (i.e., a road graph that broadly defines a set of characterising road features of roundabouts). In the context of graph isomorphism, a target graph refers to a road topology graph encoding the topology of a road layout at an appropriate level of granularity. An input graph refers to a set of topological condition(s) defining a class of subgraph. These conditions may form the basis of a query on the target graph, to locate any subgraph within the target graph that satisfies the set of topological condition(s). The term ‘input graph’ is a convenient shorthand and does not necessarily imply those conditions have to be provided as an input to the tool (they could be hard coded in the tool instead). The full SQE lane graph may be used for this purpose, or a coarser road topology graph may be used, as in roundabout detection.

Whilst the example of FIGS. 12a and 12b shows implementation of a roundabout detection tool, activated by selection of a roundabout-detect button (i.e., the interface element 196), it will be appreciated that equivalent tools for detecting other structures may alternatively or additionally be provided on the user interface 190. Where an equivalent tool is provided for identifying alternative structures, the overarching method may remain the same as in the case of the roundabout detection tool. That is, a road graph corresponding to the map 192 may constitute a target road graph, an input road graph that defines the characterising features of the alternate structure may be configured, and a query may be conducted to identify instances of graph isomorphism therebetween. Where suitable annotations/labels for an alternate structure are provided in the OpenDrive schema, annotation of such alternate structures may also be performed automatically.

### Signal Placement

In addition to enabling annotation of a static layer, the roundabout detection tool described herein may also be capable of recommending or automatically encoding new static and/or dynamic features of a road layout upon identifying a roundabout. The following description relates to automatic placement of static yield point signals, which are essentially an encoding of give way lines that would be expected on entry to a roundabout. These encoded give way lines are used by the road rules system in the test oracle 252 to ensure that vehicles give way when they should.

The roundabout detection tool may, after performing the roundabout detection process described previously herein, identify one or more entry point to a roundabout. The tool may then identify a respective target road element within each entry point. It will be appreciated that the term “entry point” may refer to junctions that are formally defined in the static layer and which are junction-grouped or otherwise associated with the roundabout.

The respective target road elements may be selected as reference road elements, with respect to which a position of a dynamic signal may be defined. The tool may be configured to select a target road element based on considerations of visibility or distance from a “stop” marker on the road, from which it is necessary for drivers (or perception systems) to have a clear view of the signal. It will be appreciated by those skilled in the art that other methods for selecting a target road element may be implemented. For example, in some embodiments, the tool may be configured to automatically encode yield points at appropriate locations within the static layer based on locations of junction elements in the static layer. That is, junctions forming entry points to roundabouts will comprise points where road elements cross over as the entry road element joins a road element in the loop. The tool may be configured to encode a yield point in the static layer at or before such a point where an entry road element overlaps a road element in the loop. A yield point may be encoded at a predetermined distance before the crossover point, or may be positioned at a distance away that is calculated as a function of some static or dynamic parameter, such as a speed limit or road width etc. In some examples, a yield point may be positioned at an intersection point between a reference line of a first entrance lane (or road) and a road element through which the closed loop of the roundabout passes.

### Controllers

In addition to defining one or more <signal> data structure, the roundabout detection tool may be further capable of defining <controller> data structures which may serve as a wrapper for the behaviour of a group of signals, or <dependency> data structures which enable the state of one or more dependent signal to be defined as a function of a primary signal.

In many cases where a roundabout comprises a plurality of associated dynamic signals, it may only be safe for a subset of those signals to display the same signal simultaneously. For example, only a subset of a plurality of traffic lights may display a green “go” state at any one time so that traffic flow remains safe and controlled.

A <dependency> element enables the state of a primary signal to control the output of one or more dependent signal. It will be appreciated that whilst a relationship between the signals may be defined using OpenDRIVE, the actual state of the primary signal (and therefore the dependent signal(s)) may be defined separately in the dynamic layer; e.g., using OpenSCENARIO.

A <controller> element defines a link between a plurality of dynamic signals, such that all dynamic signals linked under a <controller> data structure display an identical state.

In examples where the roundabout detection tool allocates more than one DSA at a roundabout, the tool may be capable of defining one or more <controller> element, and/or one or more <dependency> element when allocating DSAs at a detected roundabout, such that the states of the DSAs may be appropriately linked, e.g., before a dynamic layer is configured.

References herein to components, functions, modules and the like, denote functional components of a computer system which may be implemented at the hardware level in various ways. A computer system comprises execution hardware which may be configured to execute the method/algorithmic steps disclosed herein and/or to implement a model trained using the present techniques. The term execution hardware encompasses any form/combination of hardware configured to execute the relevant method/algorithmic steps. The execution hardware may take the form of one or more processors, which may be programmable or non-programmable, or a combination of programmable and non-programmable hardware may be used. Examples of suitable programmable processors include general purpose processors based on an instruction set architecture, such as CPUs, GPUs/accelerator processors etc. Such general-purpose processors typically execute computer readable instructions held in memory coupled to or internal to the processor and carry out the relevant steps in accordance with those instructions. Other forms of programmable processors include field programmable gate arrays (FPGAs) having a circuit configuration programmable through circuit description code. Examples of non-programmable processors include application specific integrated circuits (ASICs). Code, instructions etc. may be stored as appropriate on transitory or non-transitory media (examples of the latter including solid state, magnetic and optical storage device(s) and the like). The subsystems 102-108 of the runtime stack FIG. 1A may be implemented in programmable or dedicated processor(s), or a combination of both, on-board a vehicle or in an off-board computer system in the context of testing and the like. The various components of FIG. 2, such as the simulator 202 and the test oracle 252 may be similarly implemented in programmable and/or dedicated hardware.

### REFERENCES

Reference is made hereinabove to the following, each of which is incorporated herein by reference in its entirety:
[1] ASAM OpenDRIVE V1.6.1 (and accompanying User Guide), Release Date 4 Mar. 2021 [available at https://www.asam.net/standards/detail/opendrive/].

1. A computer-implemented method of generating road annotation data for annotating an electronic map, the method comprising:
accessing from persistent storage an electronic map defining a road network;
generating a road topology graph encoding a topology of the road network, the road topology graph comprising nodes representing road structure elements and edges representing links between road structure elements;
performing a search of the road topology graph for a predetermined graph structure;
responsive to identifying a subgraph of the road topology graph exhibiting the predetermined graph structure, generating annotation data for marking in the electronic map a portion of the road network corresponding to the subgraph; and
generating in persistent storage an augmented map comprising map data defining the portion of the road network and the annotation data.

2. The computer-implemented method of claim 1, wherein the predetermined graph structure is a closed loop structure, the subgraph comprising a plurality of nodes and a plurality of drivable links therebetween identified as forming a closed loop within the road topology graph.

3. The computer-implemented method of claim 2, wherein the predetermined graph structure is a one-way closed loop structure, the closed loop identified as being drivable in one direction only, wherein the annotation data identifies the portion of the road network as a roundabout.

4. The computer-implemented method of claim 3, wherein performing the search of the road topology graph for the predetermined graph structure comprises:
performing a first search in the road topology graph for closed loops which do not exceed a first loop length threshold, and
performing a second search for closed loops which do not exceed a second loop length threshold greater than the first loop length threshold, excluding any road structure element belonging to any loop found in the first search.

5. The computer-implemented method of claim 4, wherein performing the search of the road topology graph comprises performing a third search for closed loops which do not exceed a third loop length threshold greater than the second loop length threshold, excluding any road structure element belonging to any loop found in the first or second search.

6. The computer-implemented method of claim 4, wherein each node comprises a distance cost, wherein a total length of a sequence of nodes is determined by summing their distance costs.

7. The computer-implemented method of claim 4, wherein any nodes representing road structure elements that are determined to be not one-way in or prior to the first search are excluded from the second search.

8. The computer-implemented method of claim 4, wherein the first and second searches are restricted to loops commencing at a road structure element belonging to a junction.

9. The computer-implemented method of claim 1, wherein generating the annotation data comprises identifying one or more junctions containing a plurality of road structure elements represented by a plurality of nodes of the subgraph, wherein the portion of the road structure comprises the one or more junctions and the annotation data comprises a junction group associated with the one or more junctions.

10. The computer-implemented method of claim 9, wherein the one or more junctions contain at least one additional road structure element that is not represented by any node of the subgraph.

11. The computer-implemented method of claim 1, wherein the nodes of the road topology graph represent roads.

12. The computer-implemented method of claim 1, wherein the road topology graph is generated in processor memory.

13. The computer-implemented method of claim 1, further comprising:
rendering the road network on a graphical user interface (GUI), with a visual indicator marking the portion of the road network corresponding to the identified subgraph based on the annotation data.

14. The computer-implemented method of claim 13, wherein performing the search of the road topology graph is taken in response to receiving a user selection of a selectable element on the graphical user interface.

15. The computer-implemented method of claim 1, wherein generating the augmented map comprises augmenting the electronic map with the annotation data by generating or modifying in the electronic map at least one of a syntax element or an attribute pertaining to the portion of the road network corresponding to the identified subgraph.

16. The computer-implemented method of claim 1, wherein the annotation data comprises a wrapper element assigned to the portion of the road network corresponding to the identified subgraph.

17. (canceled)

18. The method of claim 3, wherein each road structure element of the road topology graph comprises:
a road having a start and an end, and
a direction indicator indicating a either direction towards the start of the road or towards the end of the road;
wherein each link is between a source road structure element and a destination road structure element, and indicates that traffic travelling on the road of the source road structure element in a direction indicated by the source road structure element could proceed onward to the road of the destination road structure element in a direction indicated by the destination road structure element.

19. A computer system comprising one or more computers programmed or otherwise configured to implement a method of generating road annotation data for annotating an electronic map, the method comprising:
accessing from persistent storage an electronic map defining a road network;
generating a road topology graph encoding a topology of the road network, the road topology graph comprising nodes representing road structure elements and edges representing links between road structure elements;
performing a search of the road topology graph for a predetermined graph structure;
responsive to identifying a subgraph of the road topology graph exhibiting the predetermined graph structure, generating annotation data for marking in the electronic map a portion of the road network corresponding to the subgraph; and
generating in persistent storage an augmented map comprising map data defining the portion of the road network and the annotation data.

20. The computer system of claim 19, wherein the one or more computers programmed or otherwise configured to implement:
a simulator configured to run a test scenario on the road network, with a dynamic agent controlled by a robotic planner under testing; and
a test oracle configured to select at least one performance evaluation rule based on the annotation data, evaluate performance of the dynamic agent based on the at least one performance evaluation rule, and output a test result for the robotic planner under testing.

21. A computer program product configured to program a computer system so as to carry out a method of generating road annotation data for annotating an electronic map, the method comprising:
accessing from persistent storage an electronic map defining a road network;
generating a road topology graph encoding a topology of the road network, the road topology graph comprising nodes representing road structure elements and edges representing links between road structure elements;
performing a search of the road topology graph for a predetermined graph structure;
responsive to identifying a subgraph of the road topology graph exhibiting the predetermined graph structure, generating annotation data for marking in the electronic map a portion of the road network corresponding to the subgraph; and
generating in persistent storage an augmented map comprising map data defining the portion of the road network and the annotation data.
